(19) United States
(12) Patent Application Publication
(10) Pub. No.: US 2006/0119738 A1
(43) Pub. Date: Jun. 8, 2006

(54) Image sensor, image capturing apparatus, and image processing method

(75) Inventor: Toshihito Kido, Matsubara-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/294,507

(22) Filed: Dec. 5, 2005

(30) Foreign Application Priority Data
Dec. 7, 2004 (JP) 2004-353957

(51) Int. Cl. H04N 5/14; H04N 9/73; H04N 9/64

(52) U.S. Cl. 348/571; 348/658

(57) ABSTRACT

An image sensor of present invention comprising a plurality of pixels arranged in a matrix and having pixels where at least three kinds of color filters are disposed, color pixels where the color filters are disposed and monochrome pixels where no color filter is disposed are provided, the sum total of the monochrome pixels is larger than the sum total of the color pixels, and when pixels including a predetermined number of color pixels for each kind of color filter constitute one group, the color pixels or the pixels of the groups are dispersedly disposed with the monochrome pixels in between. Compared to the image sensors in which only color pixels where color filters are disposed are arranged and the conventional image sensors in which the sum total of the monochrome pixels is equal to or smaller than the sum total of the color pixels, the effective sensitivity of the image sensor can be improved, so that photographing with high sensitivity can be performed and a beautiful image with an excellent (high) S/N ratio can be obtained.

This application is based on Japanese Patent Application No. 2004-353957 filed in Japan on 7 Dec. 2004, the entire content of which is hereby incorporated by reference.

### FIELD OF THE INVENTION

The present invention relates to the technical field of an image sensor comprising a plurality of pixels arranged in a matrix, and more particularly, to an image sensor having color pixels where color filters are disposed and monochrome pixels where no color filter is disposed, an image capturing apparatus provided with the image sensor, and an image processing method using the pixel signals obtained from the image sensor.

### DESCRIPTION OF RELATED ART

Generally, in an image sensor of a Bayer arrangement in which color filters of, for example, R (red), G (green) and B(blue) having different spectral characteristics are disposed at a ratio of 1:2:1, since the light directed to the photoelectrically conversion portions of the pixels is attenuated by the color filters, the effective sensitivity is low compared to an image sensor in which no color filter is disposed. In recent years, as image sensors have decreased in size and increased in the number of pixels, the size of one pixel has been reduced and the light reception amount per pixel is further reduced, so that the effective sensitivity of image sensors is further reduced and the dynamic range tends to be small.

Consequently, it is frequently necessary to emit flash light to ensure a necessary light reception amount, so that various problems arise such that power consumption increases to decrease the number of images that can be taken, that when a so-called camera shake compensation function is provided, the effect of compensation is small even though the camera shake compensation is performed and that the S/N ratio deteriorates (decreases) due to an increase in the amplification factor of the pixel signal obtained from each pixel.

Japanese Laid-Open Patent Application No. H09-116913 discloses an art such that in an image sensor, color filters of R (red) or B (blue) are disposed at a half of the pixels and no color filter is disposed at the remaining half of the pixels in order to improve the effective sensitivity of the image sensor.

However, according to the art of the patent document 1, since the pixels having no color filter are only a half of all the pixels of the image sensor, a significant improvement in effective sensitivity cannot be expected.

### SUMMARY OF THE INVENTION

The present invention is made in view of the above-mentioned circumstances, and an object thereof is to provide an image sensor, an image capturing apparatus and an image processing method with high effective sensitivity.

The above-mentioned object is attained by providing the following structure:

According to an image sensor of the present invention, in an image sensor comprising a plurality of pixels arranged in a matrix and having pixels where at least three kinds of color filters are disposed, color pixels where the color filters are disposed and monochrome pixels where no color filter is disposed are provided, the sum total of the monochrome pixels is larger than the sum total of the color pixels, and when pixels including a predetermined number of color pixels for each kind of color filter constitute one group, the color pixels or the pixels of the groups are dispersedly disposed with the monochrome pixels in between.

According this aspect of the invention, the effective sensitivity of the image sensor can be improved compared to the image sensors in which only color pixels where color filters are disposed are arranged and the conventional image sensors in which the sum total of the monochrome pixels is equal to or smaller than the sum total of the color pixels.

Consequently, since the effective sensitivity of the image sensor is improved, photographing with high sensitivity can be performed, so that a beautiful image with an excellent (high) S/N ratio can be obtained.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a front view of an embodiment of the image capturing apparatus according to the present invention;

FIG. 2 is a rear view of the image capturing apparatus;

FIG. 3 is a block diagram showing the electric structure of the image capturing apparatus;

FIGS. 4(a) to 4(c) are views showing an example of the arrangement of color pixels and monochrome pixels;

FIG. 5 is a view for explaining an example of a method of interpolation of the brightness data in the positions of color pixels when a live view image or a moving image is generated;

FIGS. 6(a) to 6(d) are views for explaining an example of a method of interpolation of the color data in the positions of monochrome pixels when a live view image or a moving image is generated;

FIGS. 7(a) to 7(c) are views for explaining an example of a method of interpolation of the brightness data in the positions of the color pixels when a still image is generated;

FIG. 8 is a view for explaining an example of a method of interpolation of the color data in the positions of the monochrome pixels when a still image is generated;

FIG. 9 is a flowchart showing a series of image capturing processings by the image capturing apparatus;

FIG. 10 is a flowchart showing a subroutine of step #3 of the flowchart shown in FIG. 9;

FIG. 11 is a flowchart showing a subroutine of step #8 of the flowchart shown in FIG. 9;

FIGS. 12(a) to 12(c) are views showing a modification of the interpolation of the brightness data in the positions of the color pixels;

FIG. 13 is a graph showing the characteristic of an output value (brightness value) with respect to a light reception amount P for the monochrome pixels and the color pixels;

FIGS. 14(a) and 14(b) are views for explaining a method of generating the brightness data by use of the pixel signals obtained from the color pixels;

FIG. 15 is a view showing another color pixel arrangement;

FIG. 16 is a view showing another color pixel arrangement;

FIG. 17 is a view showing another color pixel arrangement;

FIG. 18 is a view showing another color pixel arrangement;

FIG. 19 is a view showing another color pixel arrangement;

FIG. 20 is a view showing another color pixel arrangement;

FIG. 21 is a view showing another color pixel arrangement;

FIG. 22 is a view showing another color pixel arrangement;

FIG. 23 is a view showing another color pixel arrangement;

FIG. 24 is a view showing another color pixel arrangement;

FIG. 25 is a view showing another color pixel arrangement;

FIG. 26 is a view showing another color pixel arrangement;

FIG. 27 is a view showing another color pixel arrangement;

FIG. 28 is a view showing another color pixel arrangement;

FIG. 29 is a view showing another color pixel arrangement; and

FIGS. 30(a) and 30(b) are views showing another color pixel arrangement.

### DETAILED DESCRIPTION OF THE PREFERRED EMBODIMENTS

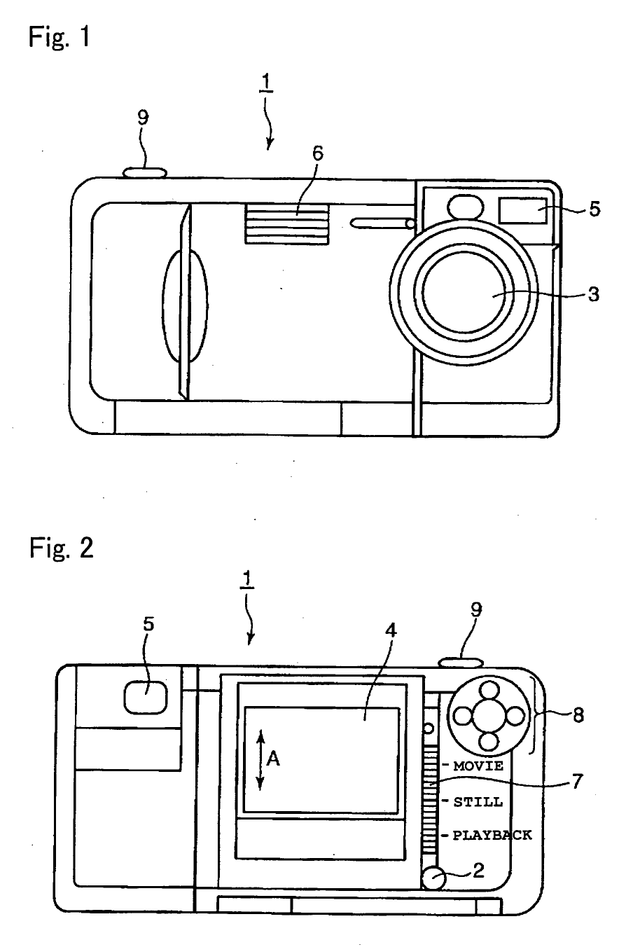

A first embodiment of the present invention will be described. FIG. 1 is a front view of an image capturing apparatus 1. FIG. 2 is a rear view of the image capturing apparatus 1.

As shown in FIGS. 1 and 2, the image capturing apparatus 1 is provided with a power button 2, an optical system 3, an LCD (liquid crystal display) 4, an optical viewfinder 5, a built-in flash 6, a mode setting switch 7, a quadruple switch 8 and a shutter button 9.

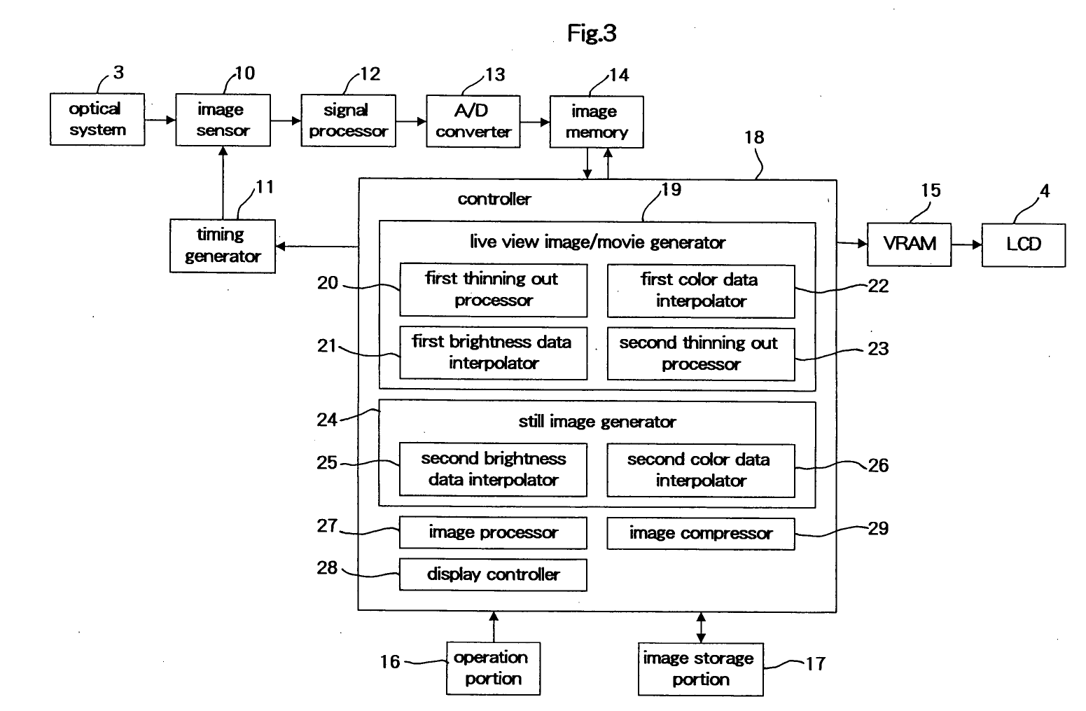

The power button 2 is for turning on and off the image capturing apparatus 1. The optical system 3 comprises a zoom lens and a non-illustrated mechanical shutter, and forms an optical image of the subject on the image capturing surface of an image sensor 10 (see FIG. 3) such as a CCD (charge coupled device).

The LCD 4 is for displaying a live view image and images recorded in an image storage portion 17 described later (see FIG. 3) (recorded image), and playing back the images recorded in the image storage portion. Instead of the LCD 4, an organic electroluminescent display or a plasma display may be used.

The live view image is a series of images displayed on the LCD 4 so as to be switched at predetermined intervals ( 1/30 second) in a period up to the recoding of the image of the subject. By the live view image, the condition of the subject is displayed substantially in real time on the LCD 4, so that the user can confirm the condition of the subject on the LCD 4.

The optical viewfinder 5 is for enabling the photographed area of the subject to be viewed optically. The built-in flash 6 applies illumination light to the subject by causing a non-illustrated discharge lamp to discharge, for example, when the amount of exposure to the image sensor 10 is insufficient.

The mode setting switch 7 is for switching the mode among a “still image photographing mode” to take still images of the subject, a “moving image photographing mode” to take moving images of the subject and a “playback mode” to play back the taken images recorded in the image storage portion 17 (see FIG. 3) on the LCD 4. The mode setting switch 7 comprises a three-position slide switch that slides vertically. When it is set at the lower position, the image capturing apparatus 1 is set in the playback mode, when it is set at the middle position, the image capturing apparatus 1 is set in the still image photographing mode, and when it is set at the upper position, the image capturing apparatus 1 is set in the moving image photographing mode.

The quadruple switch 8 is, although not described in detail, for setting a menu mode to make the setting of various functions, moving the zoom lens in the direction of the optical axis, performing exposure compensation and advancing the frame of the recorded images played back on the LCD 4.

The shutter button 9 is a button depressed in two strokes (a half depression and a full depression), and for providing the timing of the exposure control. The image capturing apparatus 1 has the still image photographing mode to take still images and the moving image photographing mode to take moving images. When the still image photographing mode or the moving image photographing mode are set, under a condition where the shutter button 9 is not operated, an optical image of the subject is captured every 1/30 (second), and the live view image is displayed on the LCD 4.

In the still image photographing mode, by the LCD 4 being half depressed, the image capturing apparatus 1 is set in a photographing standby state in which the exposure control values (the shutter speed and the aperture value) and the like are set, and by the LCD 4 being fully depressed, the exposure operation (exposure operation for recording) by the image sensor 10 to generate an subject image to be recorded in the image storage portion 17 (see FIG. 3) is started.

In the moving image photographing mode, by the LCD 4 being fully depressed, the exposure operation for recording is started, pixel signals are periodically obtained and images are successively generated by the pixel signals, and by the LCD 4 being fully depressed again, the exposure operation for recording is stopped.

FIG. 3 is a block diagram showing the electric structure of the image capturing apparatus 1. In the figure, the same members as those shown in FIGS. 1 and 2 are denoted by the same reference numerals.

The image capturing apparatus 1 is provided with the optical system 3, the LCD 4, the image sensor 10, a timing generator 11, a signal processor 12, an A/D converter 13, an image memory 14, a VRAM (video random access memory) 15, an operation portion 16, the image storage portion 17 and a controller 18.

The optical system 3 corresponds to the optical system 3 shown in FIG. 1, and has a mechanical shutter as mentioned above. The LCD 4 corresponds to the LCD 4 shown in FIG. 2.

The image sensor 10 is a CCD color area sensor in which a plurality of photoelectrical conversion elements comprising, for example, photodiodes (hereinafter, referred to as pixels) are two-dimensionally arranged in a matrix.

In the case of the conventional color area sensors of the Bayer arrangement in which color filters of, for example, R (red), G (green) and B (blue) having different spectral characteristics are disposed at a ratio of 1:2:1, since the color filters attenuate the light directed to the photodiode of the pixels, the effective sensitivity of the image sensor is low. In particular, in image sensors reduced in size and increased in the number of pixels, since the size (light reception area) of each pixel is small and the light reception amount of each pixel is small, the reduction in effective sensitivity is larger.

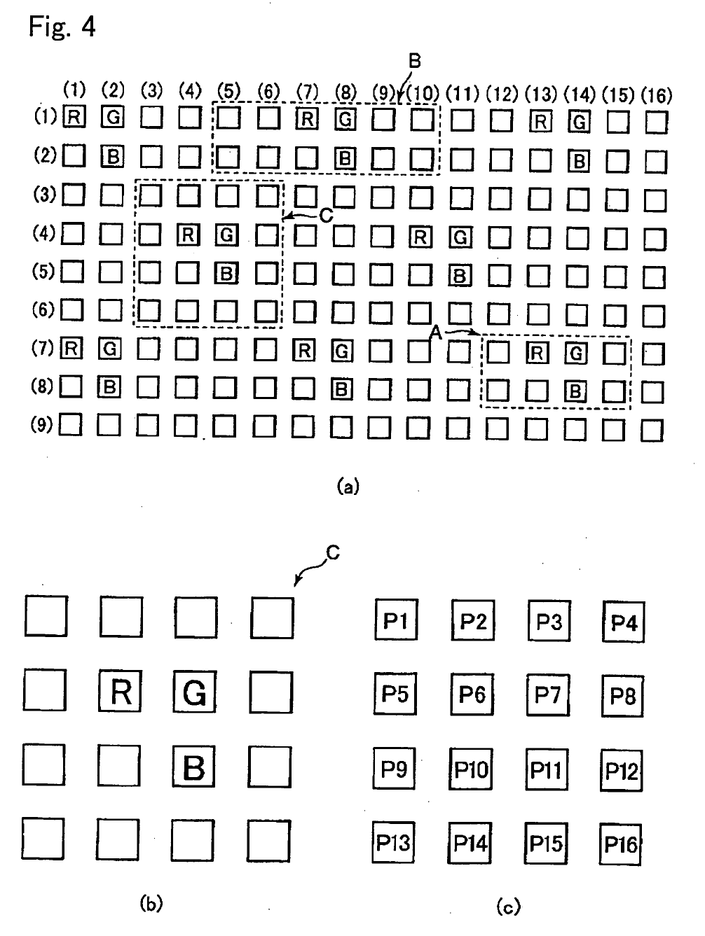

To resolve this deficiency, as shown in FIG. 4(a), the image sensor 10 of the present embodiment is provided with pixels where color filters of R (red), G (green) and B (blue) having different spectral characteristics are disposed on the light reception surface (hereinafter, referred to as color pixels) and pixels where no color filter is disposed (hereinafter, referred to as monochrome pixels; in FIG. 4(a), pixels where the letters “R,” “G” and “B” are not shown), and a plurality of groups of pixels including one each of the color pixels of R (red), G (green) and B (blue) are dispersedly disposed among a plurality of monochrome pixels so that when the number of monochrome pixels is Ws and the number of color pixels is Cs, Ws>Cs is satisfied.

That is, in the example shown in FIG. 4(a), when attention is paid to a part of the light reception area (the area comprising nine rows in the longitudinal direction and sixteen rows in the lateral direction) of the light reception surface of the image sensor 10 and the pixels are numbered from the left in the lateral direction (horizontal direction) and numbered from the top in the longitudinal direction (vertical direction), the color pixels of R (red) are disposed in the positions represented by (6n+1) in both the longitudinal and lateral directions and in the positions represented by (6n+4) in both the longitudinal and vertical directions. The color pixels of G (green) are disposed in the positions adjoining the color pixels of R (red) on the right side, and the color pixel of B (blue) are disposed in the positions adjoining the color pixels of G (green) on the lower side. The remaining pixels are all monochrome pixels having no color filter.

The sensitivity of the monochrome pixels is, for example, three times the sensitivity of the color pixels of G (green) and five times the sensitivities of the color pixels of R (red) and B (blue).

The image sensor 10 converts the light image of the subject formed by the optical system 3 into analog electric signals, and outputs the electric signals as pixel signals. From the pixel signals outputted from the color pixels, the analog color data and brightness data of the color components of R (red), G (green) and B (blue) are obtained, and from the pixel signals outputted from the monochrome signals, the brightness data is obtained.

The image sensor 10 is, for example, an interline image sensor provided with light reception portions each comprising a photodiode or the like, vertical transfer portions, horizontal transfer portions and the like, and the charges of the pixels are taken out by a progressive transfer method. That is, the charges accumulated in the light reception portions are transferred to the vertical transfer portions by a vertical synchronizing signal and the charges transferred to the vertical transfer portions are transferred to a horizontal transfer path from the pixels closer to the horizontal transfer path by a horizontal synchronizing signal, whereby the charges are taken out as pixel signals. Image capturing operations such as the readout of the output signals of the pixels at the image sensor 10 (horizontal synchronization and vertical synchronization) and the timing of the start and end of the exposure operation by the image sensor 10 are controlled by the timing generator 11 and the like described later.

As described later, in the present embodiment, the image generation method is different between when the still image photographing mode is set, and when the live view image is generated and displayed on the LCD 4 (photographing preparation period) or when the moving image photographing mode is set.

The timing generator 11 generates driving control signals of the image sensor 10, for example, clock signals such as timing signals to start/end the integration (start/end the exposure) and readout control signals (a horizontal synchronizing signal, a vertical synchronizing signal, etc.) of the light reception signals of the pixels based on a reference clock CLK0 transmitted from the controller 18, and outputs them to the image sensor 10.

The signal processor 12 performs predetermined analog signal processings on the analog pixel signals outputted from the image sensor 10. The signal processor 12 having a CDS (correlated double sampling) circuit and an AGC (automatic gain control) circuit reduces the noise of the pixel signals by the CDS circuit and adjusts the levels of the pixel signals by the AGC circuit.

The A/D converter 13 converts the analog pixel signals outputted from the signal processor 12 into digital pixel signals of a plurality of bits.

The image memory 14 temporarily stores the pixel signals outputted from the A/D converter 13, and is used as the work space for performing subsequently-described processings on the image signals by the controller 18.

The VRAM 15 is a buffer memory for the pixel signals of the image played back on the LCD 4, and has a pixel signal storage capacity corresponding to the number of pixels of the LCD 4. The operation portion 16 includes switches such as a switch that detects the release operation of the shutter button 9, the mode setting switch 7 and the quadruple switch 8.

The controller 18 comprises a microcomputer incorporating a non-illustrated storage portion comprising, for example, a ROM that stores a control program and a RAM that temporarily stores data, and controls the drivings of the above-described members so as to be associated with one another.

The brightness data in the positions of the pixels is obtained also by using the pixel signals outputted from the color pixels. However, it is considered that a bright and beautiful image can be generated while the deterioration of the S/N ratio is avoided when the brightness data in the positions of the monochrome pixels is derived by use of the pixel signals outputted from the monochrome pixels and, since the sensitivity of the monochrome pixels is higher than that of the color pixels as mentioned above, the brightness data in the positions of the color pixels is derived by an interpolation processing using the brightness data of the monochrome pixels situated around the color pixels compared to when the brightness data in the positions of the color pixels and the monochrome pixels is derived by use of the brightness data obtained by use of the pixel signals of the color pixels.

Therefore, according to the present embodiment, as described above, the brightness data in the positions of the pixels is derived by use of the brightness data obtained from the monochrome pixels.

Moreover, since no color filter is disposed at the monochrome pixels, the color data of R (red), G (green) and B (blue) in the positions of the monochrome pixels is not obtained from the monochrome pixels. Therefore, according to the present embodiment, the color data in the positions of the monochrome pixels is derived by an interpolation processing using the color data obtained from the color pixels situated around the monochrome pixels.

Since the above-mentioned interpolation processings are different between when the live view image or moving images in the moving image photographing mode are generated and when still images in the still image photographing mode are generated, these processings will be described with respect to each of these cases.

To realize this function, as shown in FIG. 3, the controller 18 is functionally provided with a live view image/moving image generator 19 and a still image generator 24.

The live view image/moving image generator 19 causes the image sensor 10 to perform the exposure operation at predetermined intervals during the photographing preparation mode and when a moving image setting mode is set, thereby generating the live view image displayed on the LCD 4 or a series of images (moving image) to be stored in the image storage portion 17. The live view image/moving image generator 19 has a first thinning out processor 20, a first brightness data interpolator 21, a first color data interpolator 22 and a second thinning out processor 23.

Since it is necessary for the live view image and the moving image only to be enough for the user to confirm the angle of view of the taken image and the like on the LCD 4 and these images are not required to have very high resolution, the first thinning out processor 20 selects some horizontal pixel rows including both color pixels and monochrome pixels from among a plurality of pixels of the image sensor 10, further selects some horizontal pixel rows from the horizontal pixel rows, and extracts the brightness data or the color data of the pixels belonging to the selected horizontal pixel rows. For example, as shown in FIGS. 4(a) to 4(c), the first, second, seventh and eighth horizontal pixel rows in the vertical direction are selected as the pixel rows which are the objects of the brightness data or color data extraction.

The first brightness data interpolator 21 derives the brightness data in the positions of, of the pixels selected by the first thinning out processor 20, the color pixels where the color filters of R (red), G (green) and B (blue) are disposed, by an interpolation processing using the brightness data obtained from the monochrome pixels situated around the color pixels.

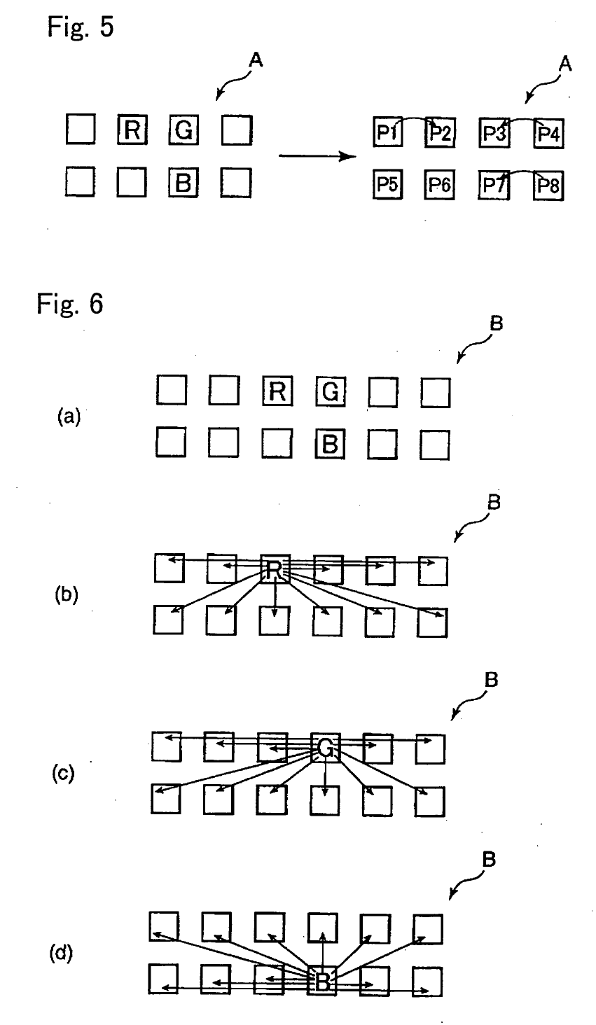

For example, in FIGS. 4(a), 4(b), 4(c) and 5, as shown by the arrow A, the pixels selected by the first thinning out processor 20 are sectioned into large blocks each comprising, for example, two pixel rows in the longitudinal direction and four pixel rows in the lateral direction including adjoining color pixels of R (red), G (green) and B (blue). At this time, the pixels of each large block is sectioned so that a small block comprising two pixel rows in the longitudinal direction and two pixel rows in the lateral direction including the color pixels of R (red), G (green) and B (blue) is situated in the center of the large block.

Then, the first brightness data interpolator 21 sets, as the brightness data in the positions of the color pixels belonging to the large block, the brightness data obtained from the monochrome pixels adjoining the color pixels in the large block.

That is, as shown in FIG. 5, when the pixels belonging to the large block are numbered P1 to P8, as the brightness data in the position of the color pixel P2 of R (red), the brightness data of the monochrome pixel Pi adjoining the color pixel P2 of R (red) on the left side is set. Moreover, the first brightness data interpolator 21 sets, as the brightness data in the position of the color pixel P3 of G (green), the brightness data of the monochrome pixel P4 adjoining the color pixel P3 of G (green) on the right side, and sets, as the brightness data in the position of the color pixel P7 of B (blue), the brightness data of the monochrome pixel P8 adjoining the color pixel P7 of B (blue) on the right side.

The arrows in FIG. 5 indicate that the brightness data of the horizontally adjoining monochrome pixel is substituted for the brightness data in the positions of the color pixels.

The first color data interpolator 22 derives the color data in the positions of the pixels selected by the first thinning out processor 20 by the interpolation processing using the color data obtained from the color pixels situated around the pixels.

For example, in FIGS. 4(a), 4(b), 4(c) and 6(a), as shown by the arrow B, the first color data interpolator 22 sections the pixels selected by the first thinning out processor 20 into large blocks each comprising two pixel rows in the longitudinal direction and six pixel rows in the lateral direction including adjoining color pixels of R (red), G (green) and B (blue). At this time, the pixels of each large block is sectioned so that a small block comprising two pixel rows in the longitudinal direction and two pixel rows in the lateral direction including the color pixels of R (red), G (green) and B (blue) is situated in the center of the large block.

Then, the first color data interpolator 22 interpolates, in each large block, the color data of the colors in the positions of the monochrome pixels by use of the color data obtained from the color pixels of the colors included in the block.

That is, as shown in FIG. 6(b), in each large block, the red data obtained from the color pixel of red included in the block is set as the color data of red in the positions of the monochrome pixels. Moreover, the first color data interpolator 22 sets, in each large block, the red data obtained from the color pixel of red included in the large block as the color data of red in the positions of the color pixels of G (green) and B (blue).

Further, as shown in FIG. 6(c), the first color data interpolator 22 sets, in each large block, the green data obtained from the color pixel of green included in the large block as the color data of green in the positions of the monochrome pixels, and sets the green data obtained from the color pixel of green included in the large block as the color data of green in the positions of the color pixels of R (red) and B (blue).

Moreover, as shown in FIG. 6 (d), the first color data interpolator 22 sets, in each large block, the blue data obtained from the color pixel of blue included in the large block as the color data of blue in the positions of the monochrome pixels, and sets the blue data obtained from the color pixel of blue included in the large block as the color data of blue in the positions of the color pixels of R (red) and G (green).

The arrows in FIGS. 6(b) to 6(d) indicate that the color data in the positions of the color pixels in the block is substituted for the color data in the positions of the monochrome pixels.

The second thinning out processor 23 thins out the pixels in the horizontal direction at the same thinning out rate as that of the first thinning out processor 20. For example, describing this with reference to the example shown in FIGS. 4(a) to 4(c), since the first thinning out processor 20 regularly thins out the horizontal pixel rows to 2/6 in the vertical direction, the second thinning out processor 23 regularly thins out the vertical pixel rows to 2/6 in the horizontal direction.

The still image generator 24 causes the image sensor 10 to perform the exposure operation with a preset exposure time (shutter speed) when the still image photographing mode is set, and generates an image (still image) by use of the pixel signals obtained from substantially all the pixels in order to generate a high-resolution image. The still image generator 24 has a second brightness data interpolator 25 and a second color data interpolator 26.

The second brightness data interpolator 25 derives the brightness data in the positions of the color pixels where the color filters of R (red), G (green) and B (blue) are disposed, by the interpolation processing using the brightness data of the monochrome pixels situated around the pixels. A method of calculating the brightness data will be described with the brightness data in the position of the color pixel of R (red) as an example.

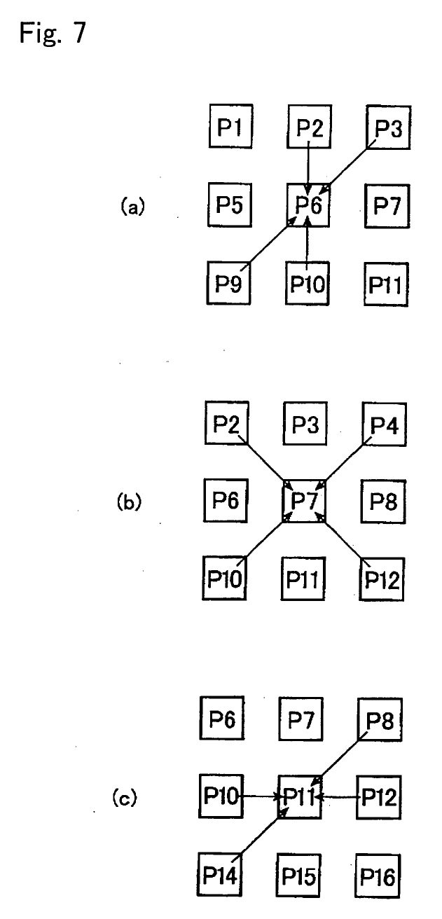

For example, when in FIGS. 4(a) and 4(b), attention is paid to pixels in four rows in the longitudinal direction and four rows in the lateral direction including adjoining color pixels of R (red), G (green) and B (blue) as shown by the arrow C and these pixels are numbered P1 to P16 as shown in FIG. 4(c), the brightness data in the position of the color pixel P6 of R (red) is interpolated, for example, by use of the brightness data of the monochrome pixels belonging to a block comprising pixels in three rows in the longitudinal direction and three rows in the lateral direction with the color pixel P6 situated in the center as shown in FIG. 7(a).

That is, in the present embodiment, in this block, a pair of monochrome pixel combinations (P2, P10) and (P3, P9) sandwiching the color pixel P6 to be interpolated are derived in any of the vertical, horizontal and slanting directions.

Then, the difference in brightness between the two monochrome pixels of each combination is calculated, and whether the brightness difference is higher or lower than a threshold value α is determined. When the brightness difference of one combination is larger than the threshold value α and the brightness difference of the other combination is smaller than the threshold value α (patterns 1 and 2), since it is considered that the brightness data in the position of the color pixel P6 to be interpolated is approximate to the brightness data of the two monochrome pixels of the combination whose brightness difference is smaller, the average value of the brightness values of the two monochrome pixels of the combination whose brightness difference is smaller than the threshold value α is calculated, and the average value is set as the brightness value (brightness data) in the position of the color pixel.

For example, when the brightness values of the pixels P1 to P16 are w1 to w16, respectively, as shown in FIG. 7(a), with respect to the two combinations (P2, P10) and (P3, P9), the brightness value w6 of the color pixel P6 is (w3+w9)/2 when |w2−w10|≧α and |w3−w9|<α, and is (w2+w10)/2 when |w2-w10|<α and |w3−w9≧α.

When the brightness differences of both of the combinations are smaller than the threshold value α (pattern 3), the average value of the brightness values of the two monochrome pixels of the combination whose brightness difference is smaller is calculated, and the average value is set as the brightness value (brightness data) of the color pixels.

When the brightness differences of both of the combinations are larger than the threshold value α (pattern 4), the average value of the brightness values of all the monochromes pixels P1 to P3, P5, P9 and P10 in the block comprising pixels in three rows in the longitudinal direction and three rows in the lateral direction, and the average value is set as the brightness value (brightness data) in the position of the color pixel P6 to be interpolated.

For example, describing this with reference to the above-described example, in the case of |w2−w10|<α and |w3−w9|<α, when |w2−w10|<|w3−w9|, the brightness value w6 of the color pixel P6 is (w2+w10)/2, and when |w2−w10|>|w3−w9|, the brightness value w6 is (w3+w9)/2. Moreover, in the case of |w2−w10|≧α and |w3−w9|≧α, the brightness value w6 of the color pixel P6 is (w1+w2+w3+w5+w9+w10)/6.

Likewise, to derive the brightness data in the position of the color pixel of G (green), as shown in FIG. 7(b), with respect to a pair of monochrome pixel combinations (P2, P12) and (P4, P10) sandwiching the color pixel P7 to be interpolated in any of the vertical, horizontal and slanting directions, and to derive the brightness data in the position of the color pixel of B (blue), as shown in FIG. 7(c), with respect to a pair of monochrome pixel combinations (P8, P14) and (P10, P12) sandwiching the color pixel P11 to be interpolated, the brightness difference between the two monochrome pixels is calculated, and the brightness data is derived according to the determination as to whether the brightness difference is larger or smaller than a predetermined threshold value.

The second color data interpolator 26 derives the color data in the positions of the monochrome pixels from the interpolation processing using the color data of the color pixels situated around the pixels. A method of calculating the color data of R (red) in the positions of the monochrome pixels will be described as an example.

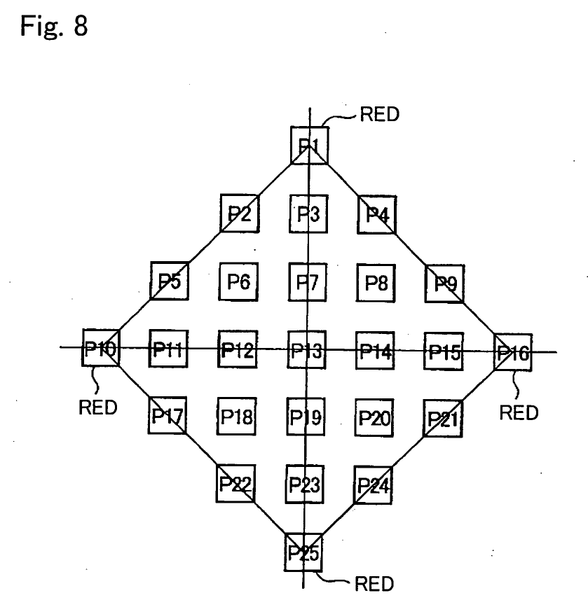

As shown in FIG. 8, attention is paid to four color pixels of R (red) arranged in a rhombus and monochrome pixels situated on the sides of the rhombus formed by the color pixels or within the rhombus. When these color and monochrome pixels are numbered P1 to P25 as shown in FIG. 8, first, the color data of R (red) in the position of the monochrome pixel P13 situated in the center of the rhombus is derived by an interpolation processing using the color data of R (red) of the color pixels P1, P10, P16 and P25 situated at the vertices of the rhombus.

In the present embodiment, the color data of R (red) in the position of the monochrome pixel P13 is the average value of the color data of the color pixels P1, P10, P16 and P25. That is, when the values represented by the color data of R (red) of the pixels P1 to P25 are denoted by r1 to r25, respectively, the value r13 represented by the color data of R (red) in the position of the monochrome pixel P13 is (r1+r10+r16+r25)/4.

Then, this rhombus is divided into four triangular areas at the diagonal lines, and the color data of R (red) in the positions of the monochrome pixels other than the monochrome pixel P13 is derived by an interpolation processing using the color data of the pixels situated at the vertices of the triangles to which the monochrome pixels belong (any of the color pixels P1, P10, P16 and P25 and the monochrome pixel P13). Hereinafter, the pixels situated at the vertices of the triangles will be referred to as vertex pixels.

In that case, when the monochrome pixel to be interpolated is situated on a side of the triangle, the vertex pixel situated on the side is derived, and a weighting factor corresponding to the distance between each of the derived vertex pixels and the monochrome pixel to be interpolated is calculated. Then, the weighted average of the color data of the derived vertex pixels is obtained by use of the weighting factors, and the average value is set as the color data of the monochrome pixel to be interpolated.

For example, as shown in FIG. 8, since the monochrome pixel P2 is situated on the side connecting the color pixel P1 and the color pixel P10, the color-pixel P1 and the color pixel P10 are derived as the vertex pixels, and the color data of R (red) in the position of the monochrome pixel P2 is derived from the color data of R (red) of the color pixel P1 and the color pixel P10.

Moreover, the reciprocal of the distance between the monochrome pixel P2 and the color pixel P1 and the reciprocal of the distance between the monochrome pixel P2 and the color pixel P10 are calculated, and the ratios “2/3” and “1/3” of the reciprocals to the sum total of the reciprocals are used as the weighting factors. This is done because it is considered that the color data in the position of the monochrome pixel to be interpolated is approximate to the color data of the vertex pixel close to the monochrome pixel, and in the present embodiment, this is done on the assumption that the color data is approximate in proportion to the reciprocal of the distance.

Then, the values obtained by multiplying the pieces of color data r1 and r10 of the vertex pixels corresponding to the distances by the corresponding weighting factors, that is, “(2/3)·r1” and “(1/3)·r10” are added together, and the sum is set as the color data r1 in the position of the monochrome pixel P2.

The color data of R (red) in the positions of the other monochrome pixels P3 to P5, P7, P9, P11 to P15 (excluding P13), P17, P19 and P21 to P24 situated on the sides of the rhombus can be calculated in a like manner.

Moreover, with respect to the monochrome pixels P6, P8, P18 and P20 not situated on the sides of the rhombus, the three vertex pixels constituting each of the triangles to which these monochrome pixels belong are derived, and the color data is derived by an interpolation processing using the color data of the vertex pixels.

For example, as shown in FIG. 8, since the monochrome pixel P6 is situated within the triangle with the color pixels P1 and P10 and the monochrome pixel P13 as the vertices, the color data in the position of the monochrome pixel P6 is derived by an interpolation processing using the color data in the position of each of the color pixels P1 and P10 and the monochrome pixel P13.

Here, in the present embodiment, the color data in the position of the monochrome pixel P6 is regarded as situated in the center of the triangle, and is the average value (r1+r10+r13)/3 of the color data of the vertex pixels P1, P10 and P13. The color data in the position of the monochrome pixel P6 to be interpolated may be derived in accordance with the actual distance between each of the vertex pixels, the color pixels P1 and P10 and the monochrome pixel P13, and the monochrome pixel P6. The color data of R (red) in the positions of the other monochrome pixels P8, P18 and P20 not situated on the sides of the rhombus can be derived in a like manner.

Further, the color data of G (green) and B (blue) in the positions of the monochrome pixels can be calculated by a like derivation method. The live view image/moving image generator 19 and the still image generator 24 correspond to the image generator as claimed in claims.

An image processor 27 performs a black level correction to correct the black level to the reference black level, a white balance adjustment to convert the levels of the digital signals of the color components of R (red), G (green) and B (blue) based on the reference of white corresponding to the light source and a gamma correction to correct the gamma characteristics of the digitals signals of R (red), G (green) and B (blue), on the images generated by the live view image/moving image generator 19 and the still image generator 24.

A display controller 28 transfers the pixel data of the image outputted from the live view image/moving image generator 19, to the VRAM 15 in order to display the image on the LCD 4. By this, the condition of the subject can be displayed on the LCD 4 in real time as the live view image until the exposure operation for recording is started.

An image compressor 29 generates compressed image data by performing a predetermined compression processing by the JPEG (Joint Picture Experts Group) method such as the two-dimensional DCT (discrete cosine transform) or the Huffman coding on the pixel data of the recorded image having undergone the above-mentioned processings by the image processor 27, and an image file comprising the compressed image data to which information related to the taken image (information such as the compression rate) is added is recorded in the image storage portion.

In the image storage portion 17, the pieces of image data are recorded in a condition of being arranged in time sequence, and in each frame, a compressed image compressed by the JPEG method is recorded together with the index information related to the taken image (information such as the frame number, the exposure value, the shutter speed, the compression rate, the date of photographing, data as to whether the flash is on or off at the time of photographing, and scene information).

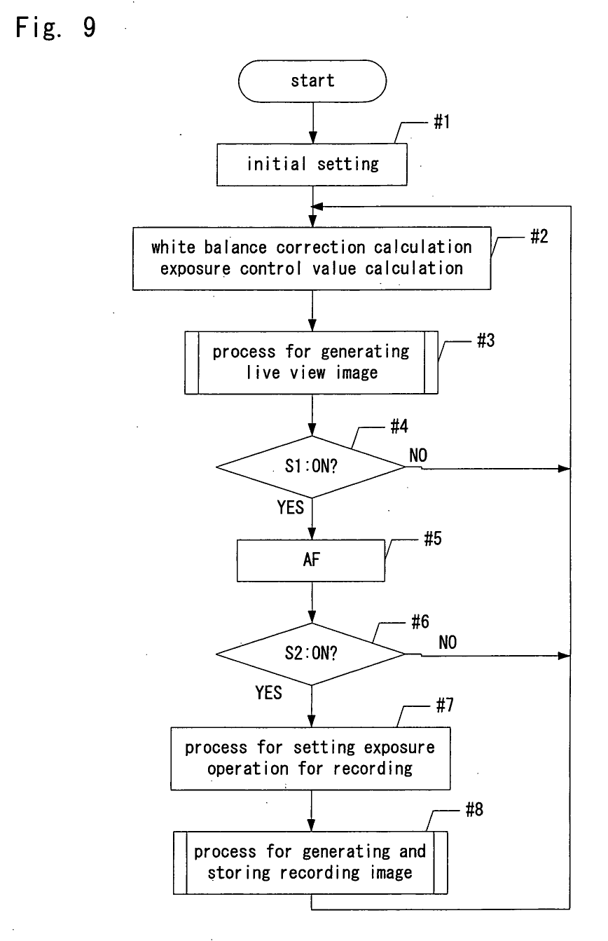

Next, a series of image capturing processings by the image capturing apparatus 1 of the present embodiment will be described with reference to the flowchart of FIG. 9.

As shown in FIG. 9, when the user of the image capturing apparatus 1 sets the photographing mode, the controller 18 performs setting processings such as the initial setting of its own and the power supply to circuits for image capturing, and causes the image sensor 10 to start the exposure operation (step #1). Then, the controller 18 performs the setting of the exposure control values (the shutter speed and the aperture value) and the gain at the signal processor, the white balance correction calculation and the like based on the image signal obtained by the exposure operation (step #2), and generates the live view image (step #3).

Then, it is determined whether a half depression of the shutter button 9 is detected by a non-illustrated switch Si or not (step #4). When no half depression is performed (No of step #4), the process returns to the processing of step #2, and the processings of steps #2 and #3 are performed. When a half depression is performed (YES of step #4), the focusing operation is performed (step #5).

Then, it is determined whether a full depression of the shutter button 9 is detected by a non-illustrated switch S2 or not (step #6). When no full depression is performed (NO of step #6), the process returns to the processing of step #2, and the processings of steps #2 to #5 are performed. When a full depression is performed (YES of step #6), after settings for the exposure operation for recording such as a change of the exposure control values set at step #2 are performed (step #7), the pixel signals for recording are generated and stored (step #8).

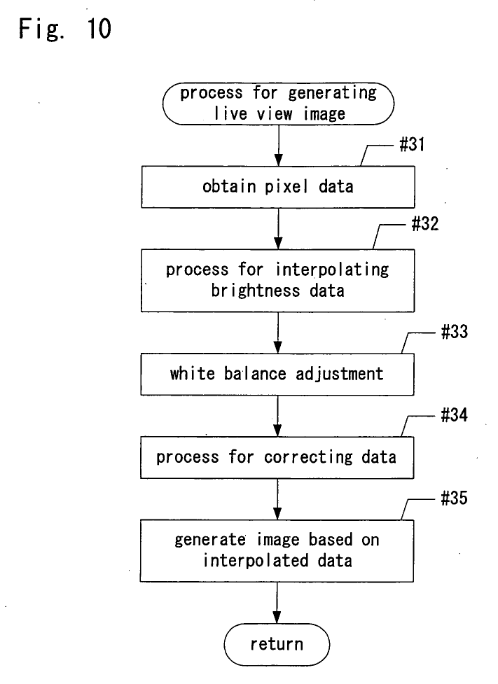

FIG. 10 is a flowchart showing a subroutine of step #3 of the flowchart shown in FIG. 9.

As shown in FIG. 10, the controller 18 repeats the processings of steps #31 to #35 during the photographing preparation period up to the half depression of the shutter button 9. First, the controller 18 causes the image sensor 10 to perform the exposure operation, and obtains the pixel data obtained by the exposure operation (step #31). Then, the controller 18 interpolates the brightness data in the positions of the color pixels by use of the brightness data of the monochrome pixels situated therearound (step S32), and then, performs the white balance adjustment on the brightness data in the positions of the monochrome pixels and the color pixels (step #33). As the interpolation processing method, the interpolation processing method shown in FIG. 5, for example, is adopted.

Next, the controller 18 interpolates the color data of R (red), G (green) and B (blue) in the positions of the monochrome pixels by use of the color data of the color pixels of R (red), G (green) and B (blue) situated therearound (step #34). As the interpolation processing method, the interpolation processing method shown in FIG. 6, for example, is adopted. Then, the controller 18 generates the live view image based on the brightness data and the color data having undergone the interpolation in the positions of the pixels (step #35).

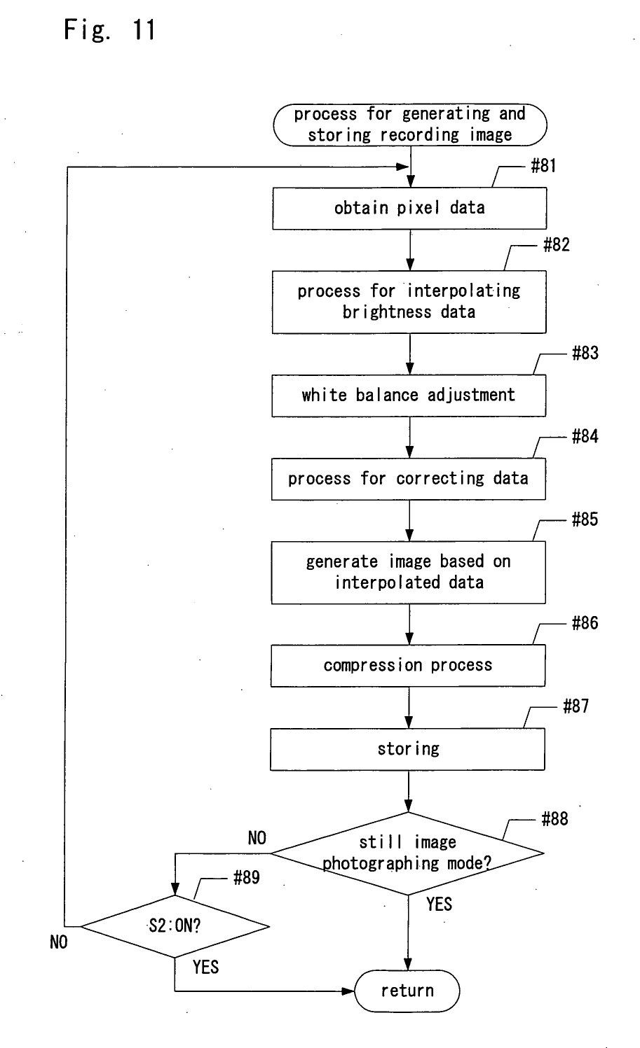

FIG. 11 is a flowchart showing a subroutine of step #8 of the flowchart shown in FIG. 9.

As shown in FIG. 11, when a full depression of the shutter button 9 is performed, the controller 18 causes the image sensor 10 to perform the exposure operation, and obtains the pixel data obtained by the exposure operation (step #81). Then, the controller 18 interpolates the brightness data in the positions of the color pixels by use of the brightness data of the monochrome pixels situated therearound (step #82), and then, performs the white balance adjustment on the brightness data in the positions of the monochrome pixels and the color pixels (step #83). As the interpolation processing method, in the case of the still image photographing mode, the interpolation processing method shown in FIG. 7, for example, is adopted, and in the case of the moving image photographing mode, the interpolation processing method shown in FIG. 5, for example, is adopted.

Then, the controller 18 interpolates the color data of R (red), G (green) and B (blue) in the positions of the monochrome pixels by use of the color data of the color pixels of R (red), G (green) and B (blue) situated therearound (step #84). As the interpolation processing method, in the case of the still image photographing mode, the interpolation processing method shown in FIG. 8, for example, is adopted, and in the case of the moving image photographing mode, the interpolation processing method shown in FIG. 6, for example, is adopted. Then, the controller 18 generates an image for recording (a still image or a moving image) based on the brightness data and the color data having undergone the interpolation in the positions of the pixels (step #85).

Then, the controller 18 performs the above-described compression processing and the like on the image for recording (step #86), and then, stores the compressed image into the image storage portion 17 (step #87). Then, when the set photographing mode is the still image photographing mode (YES of step #88), the process returns to the processing of step #2 of the flowchart shown in FIG. 9.

On the other hand, in the case of the moving image photographing mode (NO of step #88), the controller 18 determines whether a full depression of the shutter button 9 is again detected by the non-illustrated switch S2 or not (step #89). When no full-depression is performed again (NO of step #89), the process returns to the processing of step #81, and the processings of steps #81 to #88 are repeated. When a full depression is performed again (YES of step #89), the process returns to the processing of step #2 of the flowchart shown in FIG. 9.

As described above, since the image sensor 10 has color pixels where color filters of R (red), G (green) and B (blue) having different spectral characteristics are disposed and monochrome pixels where no color filter is disposed and a plurality of color pixels of R (red), G (green) and B (blue) are dispersedly disposed among a plurality of monochrome pixels so that the number of monochrome pixels is larger than the number of color pixels, the effective sensitivity of the image sensor 10 can be improved.

Although the number of color pixels is small compared to the number of monochrome pixels, since the sensitivity, to colors (hues and chromas), of the human eye is low, even when an image is generated from the color data in the positions of the monochrome pixels by interpolating the color data of the color pixels situated therearound, a taken image recognized as having high image quality can be generated.

Further, when the live view image and a moving image are generated, since the pixels belonging to the pixel row in the horizontal direction where both monochrome pixels and color pixels are present are selected as the pixels for generating the live view image and the moving image, a color live view image and moving image can be generated.

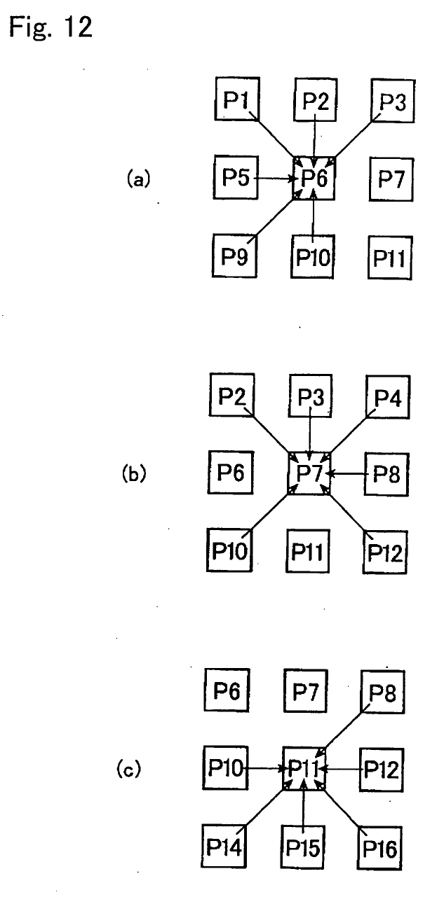

The present invention is not limited to the above-described embodiment, but the following modifications [1] to [8] are adoptable:

[1] The interpolation of the brightness data in the positions of the color pixels is not limited to that of the above-described embodiment, but the following mode is adoptable: FIG. 12(a) to 12(c) are views showing a modification of the interpolation of the brightness data in the positions of the color pixels.

As shown in FIGS. 4(a) to 4(c) and 12(a) to 12(c), when pixels in four rows in the longitudinal direction and four rows in the lateral direction including adjoining color pixels of R (red), G (green) and B (blue) are numbered P1 to P16, the brightness data in the position of the color pixel P6 of R (red) may be interpolated by use of the brightness data of all the monochrome pixels belonging to a block comprising the pixels in three rows in the longitudinal direction and three rows in the lateral direction with the color pixel P6 in the center.

For example, as shown in FIG. 12(a), when the brightness data in the position of the color pixel P6 of R (red) is derived, in the block comprising the pixels in three rows in the longitudinal direction and three rows in the lateral direction with the color pixel P6 in the center, the brightness data of the monochrome pixels P1 to P3, P5, P9 and P10 is extracted. Then, the average value (w1+w2+w3+w5+w9+w10)/6 of the brightness data of the monochrome pixels P1 to P3, P5, P9 and P10 is calculated, and the average value is set as the brightness data in the position of the color pixel P6 of R (red).

Likewise, when the brightness data in the position of the color pixel of G (green) is derived, as shown in FIG. 12(b), the average value (w2+w3+w4+w8+w10+w12)/6 of the brightness data of the monochrome pixels P2 to P4, P8, P10 and P12 in a block comprising pixels in three rows in the longitudinal direction and three rows in the lateral direction with the color pixel P7 in the center is calculated, and the average value is set as the brightness data in the position of the color pixel P7 of G (green).

When the brightness data in the position of the color pixel of B (blue) is derived, as shown in FIG. 12(c), the average value (w8+w10+w12+w14+w15+w16)/6 of the brightness data of the monochrome pixels P8, P10, P12, P14 to P16 in a block comprising pixels in three rows in the longitudinal direction and three rows in the lateral direction with the color pixel P11 in the center is calculated, and the average value is set as the brightness data in the position of the color pixel P11 of B (blue).

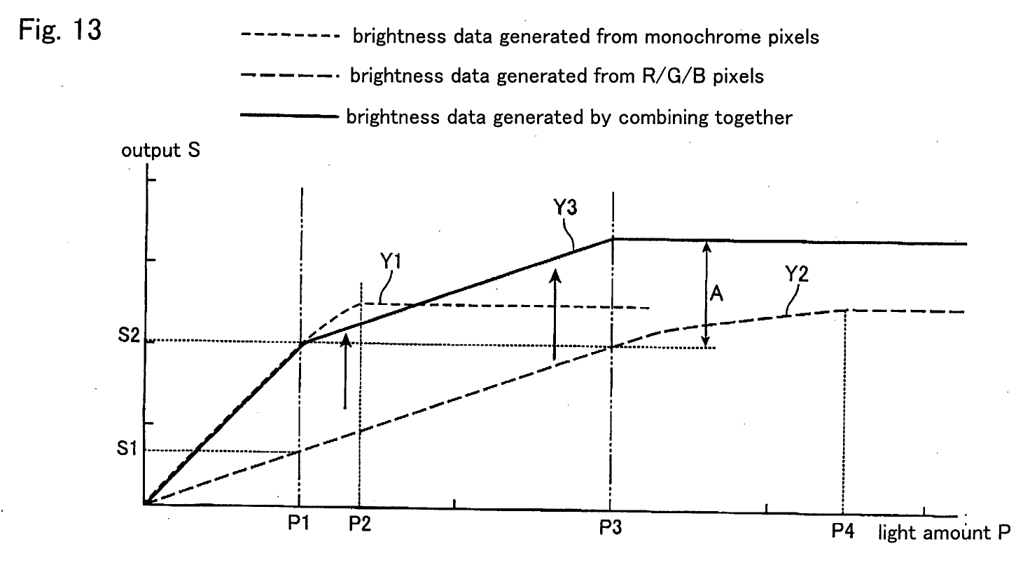

As described above, as the brightness data in the position of the color pixel to be interpolated, the average of the brightness data of all the monochrome pixels adjoining the color pixel may be set.

[2] Since the brightness data can be obtained not only from the monochrome pixels but also from the color pixels, the gradation of the brightness can be increased by using the brightness data obtained from both the monochrome pixels and the color pixels. FIG. 13 is a graph showing the characteristic of an output value (brightness value) S with respect to a light reception amount P for the monochrome pixels and the color pixels.

As shown in FIG. 13, the monochrome pixels (shown as “pixel of W” in FIG. 13) have a characteristic such that the output value increases substantially at a constant rate when the light reception amount P is in a range of 0<P<P2 and the output is saturated when the light reception amount P becomes P2.

On the other hand, the color pixels have a characteristic such that when the light reception amount P is in a range of 0<P<P3 (P3>P2), the output value increases at a constant rate lower than the increase rate of the output value of the monochrome pixels in the range of 0<P<P2, when the light reception amount P is in a range of P3<P<P4, the increase rate is lower than that in the range of 0<P<P3 and when the light reception amount P becomes P4 (>P3), the output is saturated.

As described above, there is a range of the light reception amount where the output values of the color pixels are not saturated although the output values of the monochrome pixels are saturated and in FIG. 13, the range (sensitivity range) of the light reception amount P where the appropriate output S (brightness value) is obtained is P1<P<P2 for the color pixels, whereas the sensitivity range of the monochrome pixels is 0<P<P1 and the sensitivity range of the color pixels is shifted with respect to that of the monochrome pixels.

Therefore, with respect to the pixels where, for example, with the output value S1 of the color pixels or the output value S2 of the monochrome pixels corresponding to the light reception amount P1 as the boundary, the brightness data of the monochrome pixels or the brightness data obtained by the interpolation from the monochrome pixels in the positions of the pixels is in a range of 0<S<S2 or the brightness data obtained from only the color pixels or the brightness data obtained by the interpolation processing using the brightness data in the positions of the pixels is in a range of 0<S<S1, an image is generated by use of only the brightness data obtained from the monochrome pixels.

Moreover, with respect to pixels with comparatively high brightness where the brightness data of the monochrome pixels or the brightness data obtained by the interpolation from the monochrome pixels is in a range of S>S2 or the brightness data obtained from only the color pixels or the brightness data obtained by the interpolation processing using the brightness data is in a range of S>S1, an image is generated by combining together, adding together in the present embodiment, the brightness data obtained from the monochrome pixels and the brightness data obtained from the color pixels.

By this, compared to when an image is generated from only the brightness data obtained from the monochrome pixels, the dynamic range is increased from the range of 0<P<P2 to the range of 0<P<P3, gradation can be expressed also for a subject image (equivalent) that is high in brightness by the range of P1<P<P3 of the light reception amount P corresponding to the range shown by the arrow A of FIG. 13. Consequently, the gradation of the brightness can be increased. Moreover, the gradation of the brightness can be increased by a simple combining processing as described above.

As a method of generating the brightness data by use of the pixel signals obtained from the color pixels, the following method, for example, is adopted:

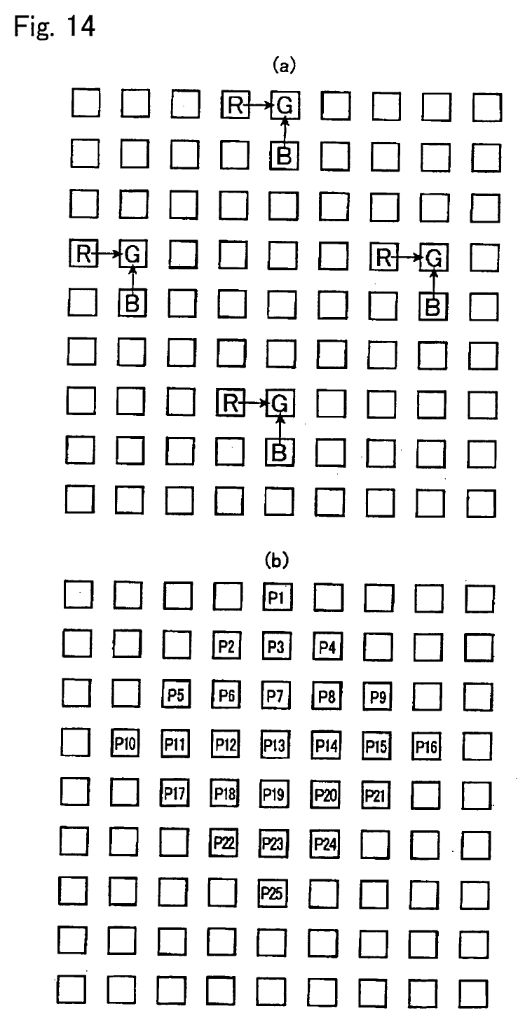

For example, in the arrangement of the color pixels and the monochrome pixels shown in FIGS. 4(a) to 4(c), attention is paid to the four color pixels of G (green) arranged in a rhombus and the color pixels of R (red) and B (blue) adjoining these color pixels as shown in FIG. 14(a), regarding the color pixels of R (red) and B (blue) adjoining the color pixels of G (green) as present in the positions of the color pixels of G (green), the brightness data is derived by use of the pixel signals obtained from the color pixels of R (red) and B (blue) and the pixel signals obtained from the color pixels of G (green).

After the brightness data in the position of each color pixel of G (green) is calculated in this manner, as shown in FIG. 14(b), the brightness data in the position of the monochrome pixel P13 situated in the center of the rhombus is derived based on the brightness data, and the brightness data in the positions of the other monochrome pixels P2 to P9, P11, P12, P14, P15 and P17 to P24 in the rhombus is derived by an interpolation processing using the brightness data in the positions of the five pixels P1, P10, P13, P16 and P25. This brightness data interpolation processing method is not described because it is similar, for example, to the method shown in FIG. 11,

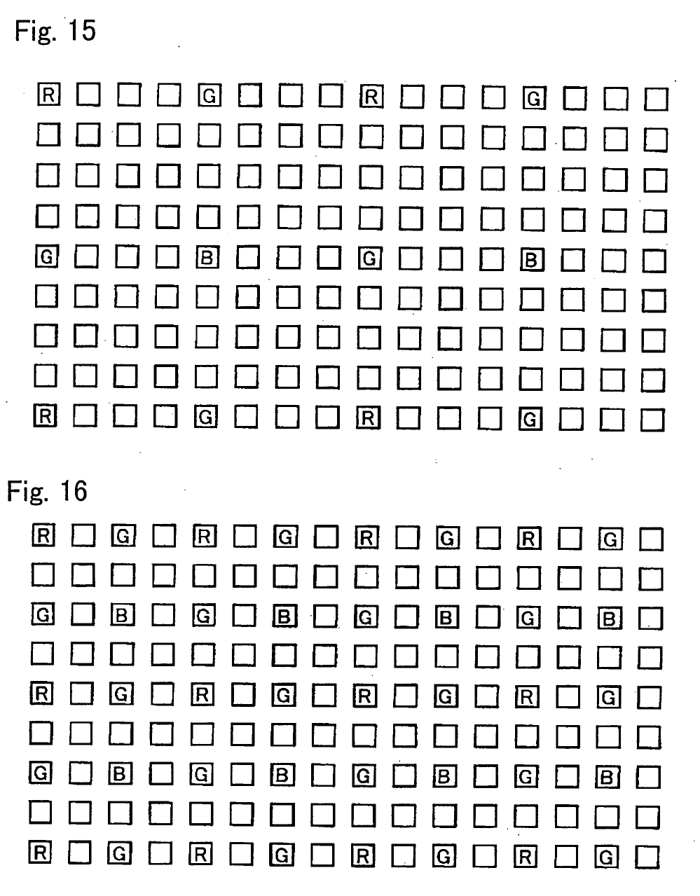

The brightness values at the boundary to determine whether the brightness data obtained from the monochrome pixels and the brightness data obtained from the color pixels are combined together or not are not limited to the brightness values S1 and S2, but may be set as appropriate within a range where the monochrome pixels are not saturated.

[3] The color pixel arrangement is not limited to that of the above-described embodiment (see FIGS. 4(a) to 4(c)), but color pixel arrangements as shown in FIGS. 15 to 29 described in the following are adoptable: When pixels including a predetermined number of color pixels for each kind of color filter constitute a group, the color pixels or the pixels of the groups are dispersedly disposed with monochrome pixels in between.

The color pixel arrangements shown in FIGS. 15 and 16 show examples in which the color pixels are dispersedly disposed with monochrome pixels in between. The color pixels are arranged with a predetermined number (three in FIG. 15 and one in FIG. 16) of monochrome pixels in between in each of the longitudinal and lateral directions, and when attention is paid only to the color pixels, those color pixels are Bayer-arranged.

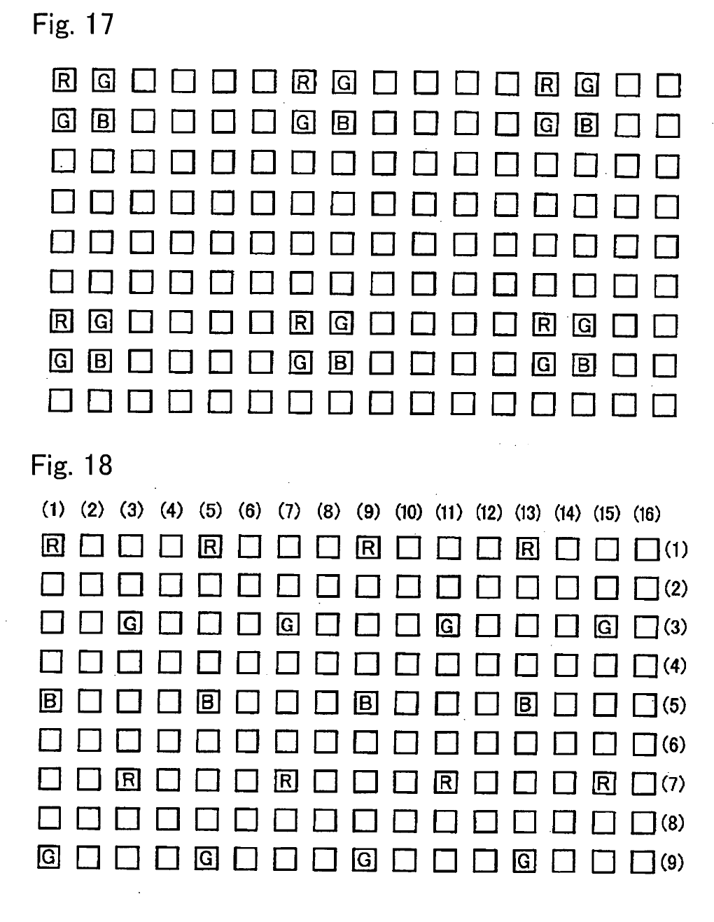

The color pixel arrangement shown in FIG. 17 shows an example in which groups of pixels including a predetermined number of color pixels of R (red), G (green) and B (blue) for each kind of color filter are dispersedly disposed with monochrome pixels in between. Color pixel groups including four color pixels are arranged with a predetermined number (four in FIG. 17) of monochrome pixels in between in each of the longitudinal and lateral directions, and in each color pixel group, color pixels of R (red), G (green) and B (blue) are Bayer-arranged at a ratio of 1:2:1.

In this case, a processing system that processes pixel signals of the conventional image sensors where only color pixels are Bayer-arranged (image sensors having no monochrome pixel) can be adopted.

In the color pixel arrangement shown in FIG. 18, when the pixels are numbered from the upper left pixel in the horizontal and vertical directions, color pixels are disposed in positions whose positions (coordinates) in the horizontal and vertical directions are represented by (4m+1, 4n+1) (m and n are integers) or in positions whose positions in the horizontal and vertical directions are represented by (4m+3, 4n+3) (m and n are integers), color pixels of the same colors are arranged in the horizontal direction, and in the vertical direction, color pixels of R (red), G (green) and B (blue) are arranged so as to repetitively occur in turn.

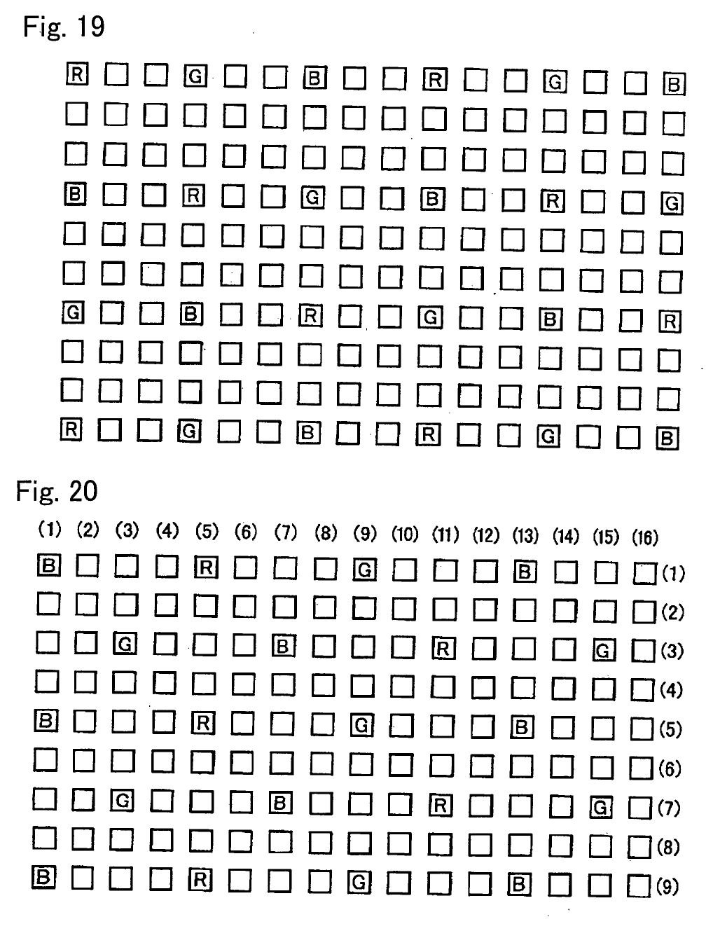

In the color pixel arrangement shown in FIG. 19, color pixels are arranged with a predetermined number (two in FIG. 19) of monochrome pixels in between in each of the longitudinal and lateral directions, and when attention is paid to the pixel rows in the horizontal and vertical directions where color pixels are disposed, color pixels of R (red), G (green) and B (blue) are arranged so as to repetitively occur in turn in both directions.

In this case, since color pixels of R (red), G (green) and B (blue) are disposed in one pixel row extending in the horizontal direction, when the live view image is generated, only the pixel rows where color pixels are disposed are selected and the pixel data is extracted from the pixels belonging to the selected pixel rows to thereby generate the live view image.

In the color pixel arrangement shown in FIG. 20, when the pixels are numbered from the upper left pixel in the horizontal and vertical directions, color pixels are disposed in positions whose positions in the horizontal and vertical directions are represented by (4m+1, 4n+1) (m and n are integers) or in positions whose positions in the horizontal and vertical directions are represented by (4m+3, 4n+3) (m and n are integers), color pixels of the same color are arranged in the vertical direction, and in the horizontal direction, color pixels of R (red), G (green) and B (blue) are arranged so as to repetitively occur in turn.

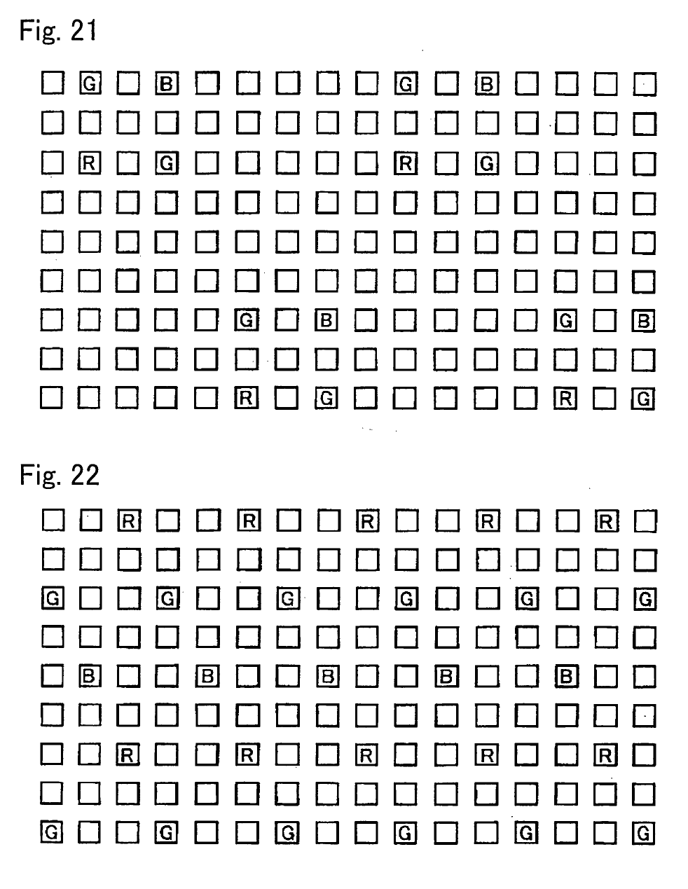

In the color pixel arrangement shown in FIG. 21, a plurality of groups each constituted by n (longitudinally)×n (laterally) (n=3 in FIG. 21) pixels including color pixels of R (red), G (green) and B (blue) disposed in the angular parts so that the Bayer arrangement is established when attention is paid only to the color pixels are disposed with predetermined pixel rows (five rows in FIG. 21) in between in the horizontal direction, and a plurality of pixel rows arranged in such a manner are disposed with a predetermined number of pixel rows (three rows in FIG. 21) in between in the vertical direction and are shifted from the groups of n (longitudinally)×n (laterally) pixels situated above and below them by a predetermined number (one in FIG. 21) of pixels in the horizontal direction.

In the color pixel arrangement shown in FIG. 22, pixel rows including color pixels of the same color arranged with a predetermined number (two in FIG. 22) of monochrome pixels in between in the horizontal direction are provided for each of color pixels of R (red), G (green) and B (blue), and the pixel rows having color pixels are disposed every n lines (every other line in FIG. 22) in the vertical direction in such a manner that the color pixels of R (red), G (green) and B (blue) are situated in different positions in the horizontal direction.

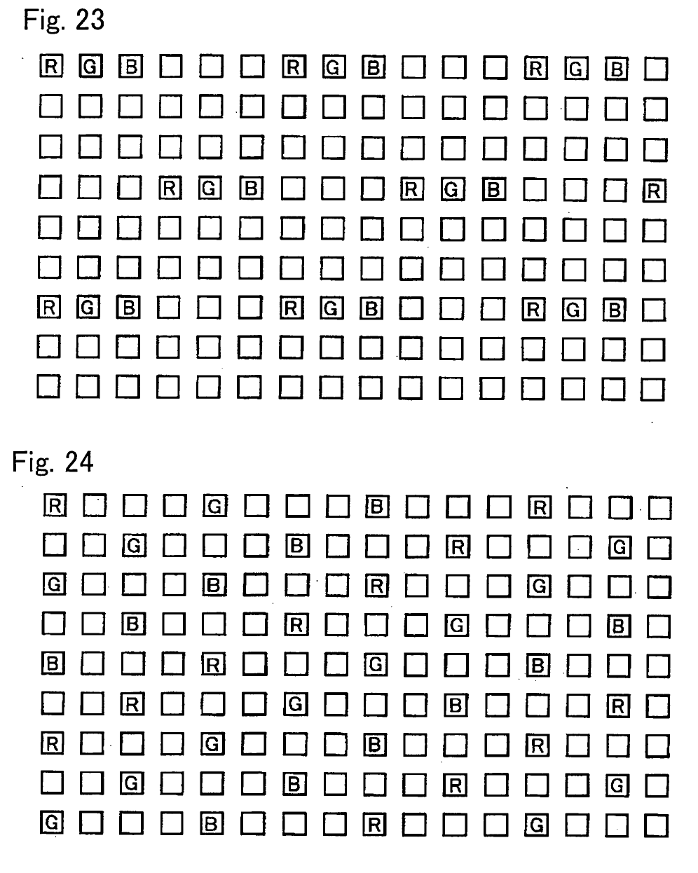

In the color pixel arrangement shown in FIG. 23, pixel groups including one each of the color pixels of R (red), G (green) and B (blue) arranged in the horizontal direction are disposed with a predetermined number (three in FIG. 23) of monochrome pixels in between in the horizontal direction to constitute a color pixel row, the color pixel rows are disposed with a predetermined number of pixel rows (two rows in FIG. 23) in between in the vertical direction, and when attention is paid only to the color pixel rows, in two vertically adjoining color pixel rows, the pixel groups are arranged so as to alternate in the horizontal direction.

In this case, since the color pixels of R (red), G (green) and B (blue) in one pixel group are disposed so as to adjoin (gather) together, compared to when the color pixels of R (red), G (green) and B (blue) in one pixel group are disposed so as to be separate from one another, the brightness data and the color data can be more accurately interpolated, so that false colors are less frequently generated.

That is, for example, in a case where color pixels where color filters of the same color are disposed (hereinafter, referred to as first and second color pixels) are arranged so as to be separate from one another, when the pixel signal (color signal) in the position of a color pixel where a color filter of a different color is disposed which color pixel is situated between the first and second color pixels is interpolated by use of the pixel signals of the first and second color pixels, there are cases where the color signal derived by the interpolation is significantly different between when the color boundary is present on the first color pixel side of the pixel to be interpolated and when it is present on the second color pixel side thereof, and consequently, there are cases where the color in the position of the monochrome pixel to be interpolated cannot be accurately reproduced.

On the contrary, according to the present invention, since color pixels where color filter of different colors are disposed are arranged so as to adjoin together, the color signals of colors different from those of the color pixels in the positions of the color pixels can be interpolated by the color pixels adjoining the color pixels, so that the above-mentioned problem can be avoided or suppressed.

In the color pixel arrangement shown in FIG. 24, color pixels of R (red), G (green) and B (blue) are arranged so as to repetitively occur in turn with a predetermined number (three in the horizontal direction and one in the vertical direction in FIG. 24) of monochrome pixels in between in the horizontal and vertical directions.

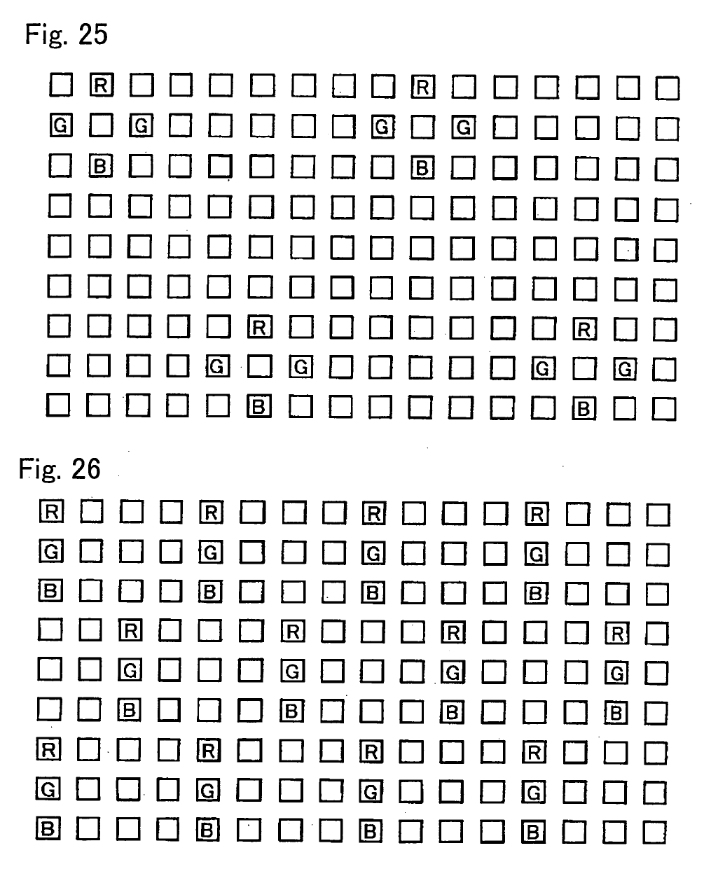

In the color pixel arrangement shown in FIG. 25, in the n (longitudinally)×n (laterally) pixels defined in the description of the color pixel arrangement shown in FIG. 21, instead of disposing the color pixels of R (red), G (green) and B (blue) in the angular parts, the pixels situated in the centers of the sides of the square constituted by the pixels are color pixels (pixels arranged so as to form a rhombus). In FIG. 25, in each pixel group, the pixels situated at the two vertices arranged in the horizontal direction of the rhombus are color pixels of G (green), and the pixels situated at the vertices situated above and below them are color pixels of R (red) and B (blue), respectively.

In the color pixel arrangement shown in FIG. 26, pixel groups including one each of the color pixels of R (red), G (green) and B (blue) arranged in the vertical direction are disposed with a predetermined number (three in FIG. 26) of monochrome pixels in between in the vertical direction to constitute a color pixel row, the color pixel rows are arranged with a predetermined number (one in FIG. 26) of pixel rows in between in the horizontal direction, and when attention is paid only to the color pixel rows, in two horizontally adjoining color pixel rows, the pixel groups are arranged so as to alternate in the vertical direction.

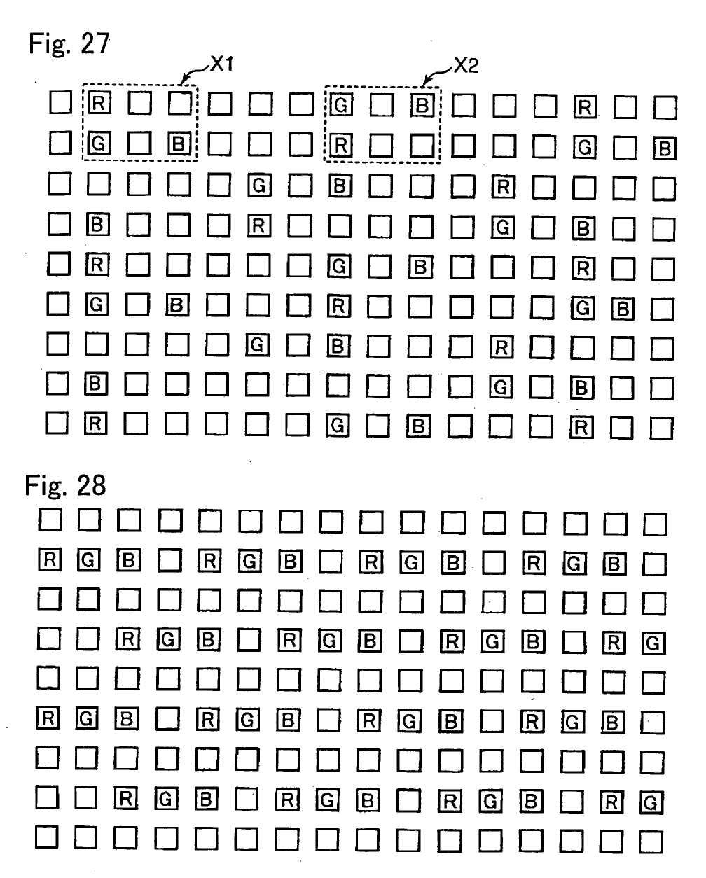

In the color pixel arrangement shown in FIG. 27, first pixel groups X1 each including a color pixel of G (green), a color pixel of R (red) adjoining the color pixel of G (green) on the upper side and a color pixel of B (blue) situated on the right side of the color pixel of G (green) with one monochrome pixel in between and second pixel groups X2 each including a color pixel of G (green), a color pixel of R (red) adjoining the color pixel of G (green) on the lower side and a color pixel of B (blue) situated on the right side of the color pixel of G (green) with one monochrome pixel in between are arranged, in a pair of pixel rows arranged in the vertical direction, so as to alternate with a predetermined number (three in FIG. 27) of monochrome pixel rows in between in the horizontal direction, the pair of pixel rows including the first and second pixel groups X1 and X2 are provided in a plurality of numbers in the vertical direction, and when attention is paid to a pair of upper and lower pixel groups with the pair of pixel rows being regarded as a group, the positions of the pixels of the pixel group situated on the lower side are shifted from those of the pixels of the pixel group situated on the upper side by a predetermined number of pixel rows (two rows in FIG. 27) in the horizontal direction (leftward in FIG. 27).

In the color pixel arrangement shown in FIG. 28, pixel rows are provided in which pixel groups including one each of the color pixels of R (red), G (green) and B (blue) arranged in the horizontal direction are disposed with a predetermined number (one in FIG. 28) of monochrome pixels in between in the horizontal direction, the pixel rows are arranged with a predetermined number (one in FIG. 28) of pixel rows in between in the vertical direction, and when attention is paid to two adjoining pixel rows among the pixel rows in which color pixels are disposed, the pixel situated at an end of each pixel group is situated in the same position in the horizontal direction as the pixel situated at the opposite end of the pixel group in the adjoining pixel row.

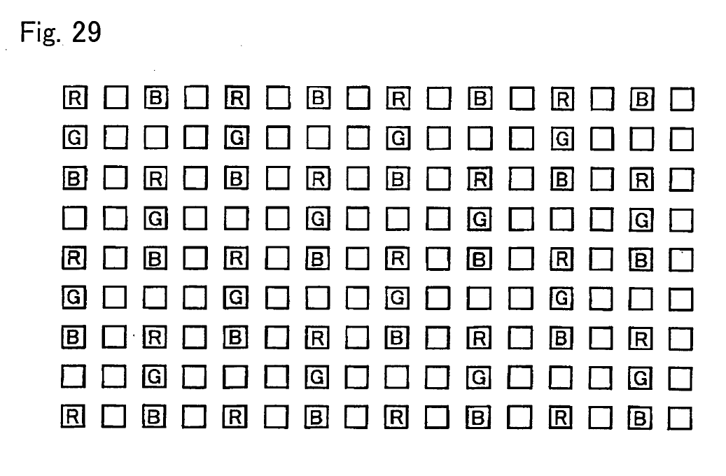

In the color pixel arrangement shown in FIG. 29, pixel rows are provided in which pixel groups including one each of the color pixels of R (red), G (green) and B (blue) arranged in the vertical direction are disposed with a predetermined number (one in FIG. 29) of monochrome pixels in between in the vertical direction, the pixel rows are arranged with a predetermined number (one in FIG. 29) of pixel rows in between in the horizontal direction, and when attention is paid to two adjoining pixel rows among the pixel rows in which color pixels are disposed, the pixel situated at an end of each pixel group is situated in the same position in the vertical direction as the pixel situated at the opposite end of the pixel group in the adjoining pixel row.

[4] The color data interpolation processing is not limited to the above-described one; for example, the following may be adopted:

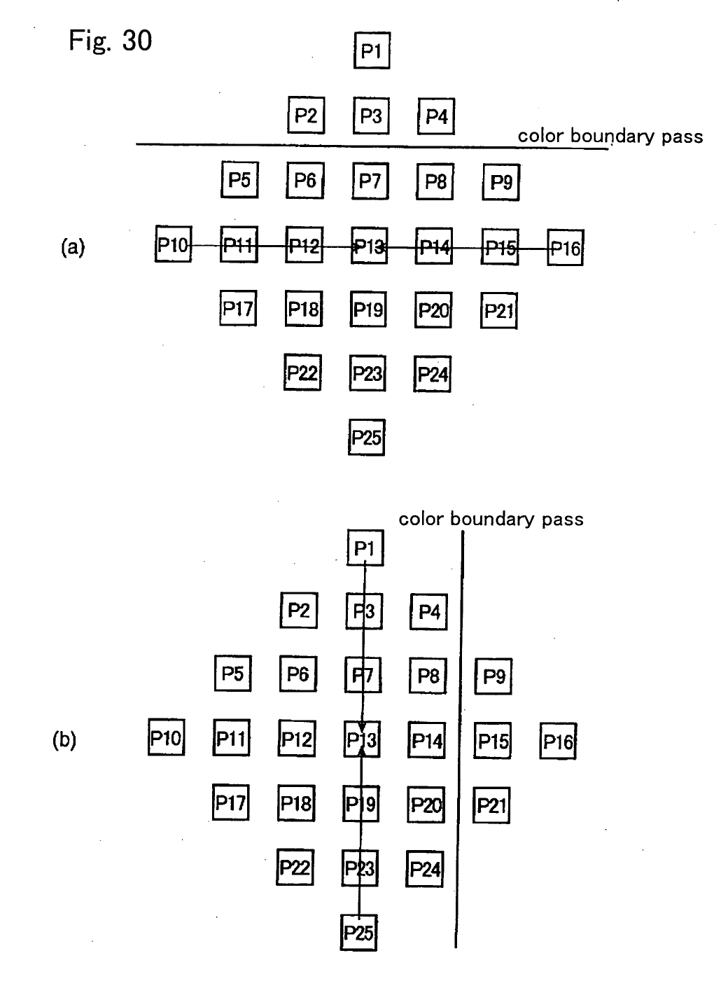

As shown in FIGS. 30(a) and 30(b), attention is paid to four color pixels of R (red) arranged in a rhombus like in FIG. 8, and monochrome pixels situated on a side of the rhombus formed by the color pixels or within the rhombus are extracted. When these color pixels and monochrome pixels are numbered from P1 to P25, first, the color data of R (red) of the monochrome pixel P13 situated in the center of the rhombus is derived by an interpolation processing using the color data of R (red) of the color pixels P1, P10, P16 and P25 situated at the vertices of the rhombus.

In that case, according to the present embodiment, for the color data of R (red) in the position of the monochrome pixel P13, a pair of combinations of color pixels of R (red) (P1, P25) and (P10, P16) situated at the vertices of the rhombus and opposed with the monochrome pixel P13 in between are derived.

Then, in the combinations (P1, P25) and (P10, P16), the difference in color data between the two color pixels is calculated, and whether the color data difference is larger or smaller than a threshold value β is determined. When one color data difference is larger than the threshold value β and the other color data difference is smaller than the threshold value β, the average value of the color data of the two color pixels of the combination whose color data difference is smaller is calculated, and the average value is set as the color data in the position of the monochrome pixel P13.

This is because it can be considered that as shown in FIGS. 30 (a) and 30(b), the possibility is high that the color boundary passes through any position between the two color pixels belonging to the combination whose color difference is larger than the threshold value β and the possibility is low that the color boundary passes between the two color pixels belonging to the combination whose color difference is smaller than the threshold value β.

Moreover, when the color data differences are both smaller than the threshold value β, the average value of the color data of the two color pixels belonging to the combination whose color data difference is smaller is calculated, and the average value is set as the color data in the position of the monochrome pixel P13. Moreover, when the color data differences are both larger than the threshold value β, the average value of the color data of all the color pixels P1, P10, P16 and P25 is calculated, and the average value is set as the color data in the position of the monochrome pixel P13.

The interpolation method for the color data in the positions of the other monochrome pixels P2 to P9, P11, P12, P14, P15 and P17 to P24 will not be described because it is similar to the interpolation method described with reference to FIG. 8. The color data of G (green) and B (blue) in the positions of the monochrome pixels can also be calculated in a similar manner.

The color boundary can be estimated based on brightness (density) changes. For example, in the above-described example, when the difference in brightness data between the positions of the two color pixels in each of the combinations (P1, P25) and (P10, P16) is calculated, it can be considered that the possibility is high that the color boundary passes through any position between the two color pixels belonging to the combination whose brightness data difference is larger and the possibility is low that the color boundary passes between the two color pixels belonging to the combination whose brightness data difference is smaller.

[5] When the exposure control is performed by use of only the brightness data obtained from the monochrome pixels, the exposure control can be accurately performed (the shutter speed, the aperture value and the like can be accurately set) compared to when the exposure control is performed based on the brightness data obtained from the color pixels.

That is, in the conventional image sensors comprising only color pixels of R (red), G (green) and B (blue), the brightness data is generated from the pixel data obtained from the color pixels, and the exposure control is performed based on the brightness data. However, there is a possibility that an error with respect to the actual brightness of the subject is caused because of the brightness data generation processing.

Moreover, when most of the pixels for obtaining images for recording are monochrome pixels like the present invention, since there is a large brightness difference between the pieces of brightness data obtained from the monochrome pixels and the color pixels that are significantly different in sensitivity, using these in mixture for the exposure control also becomes a cause of the error.

On the contrary, in the present embodiment, since the brightness data obtained from only the monochrome pixels is used, the brightness data generation processing as described above is unnecessary, so that the above-mentioned error that can be caused because of the generation processing is never caused. By this, the exposure control can be accurately performed. Moreover, since the effective sensitivity of the image sensor 10 is high because of the provision of the monochrome pixels, the exposure control can be accurately performed even for a dark image. The exposure control is performed by an exposure condition determiner (corresponding to the exposure condition determiner as claimed in claims) in the controller 18.

[6] When an image sensor of a type that specifies a given pixel from among a plurality of pixels and causes the selected pixel to output a pixel signal is used instead of the above-described image sensor, the pixel signal readout from the monochrome pixels and the pixel signal readout from the color pixels can be separately performed such as reading out the pixel signals from the monochrome pixels first and then, reading out the pixel signals from the color pixels, so that compared to when the pixel signals from the monochrome pixels and the pixel signals from the color pixels are present in mixture, the pixel signal processing is easy. Consequently, the processing time can be reduced and the structure of the signal processing system can be simplified.

[7] While a mode provided with one each of the signal processor 12, the A/D converter 13 and the image memory 14 is described as the first embodiment of the present invention, the present invention is not limited thereto; two each of the signal processor 12, the A/D converter 13 and the image memory 14 may be provided.

With this, for example, the processing of the pixel signals obtained from the color pixels and the processing of the pixel signals obtained from the monochrome pixels can be performed in parallel, and in another signal processor 12, by amplifying the pixel signals obtained from the monochrome pixels and the pixel signals obtained from the color pixels at different amplification factors, the SIN ratio can be improved.

Further, since the pixel signal processing can be performed with the pixel signals from the monochrome pixels and the pixel signals from the color pixels being separated from each other, the pixel signal processing is easy compared to when the pixel signals are present in mixture, so that the processing time can be reduced and the structure of the signal processing system can be simplified. Consequently, for example, the white balance adjustment performed only by the pixel signals obtained from the color pixels can be easily performed.

[8] While the colors of the color filters disposed at the color pixels are R (red), G (green) and B (blue) in the above-described embodiment, the present invention is not limited thereto; the colors may be C (cyan), M (magenta), Y (yellow) and G (green). In this case, for example, the color pixel arrangement is such that, like those of FIGS. 15 to 17, 21 and 25, for the pixel group including one color pixel of R (red), two color pixels of G (green) and one color pixel of B (blue), instead of these color pixels, color pixels where color filters of C (cyan), M (magenta), Y (yellow) and G (green) are disposed.

As described above, according to an image sensor of the present invention, in an image sensor comprising a plurality of pixels arranged in a matrix and having pixels where at least three kinds of color filters are disposed, color pixels where the color filters are disposed and monochrome pixels where no color filter is disposed are provided, the sum total of the monochrome pixels is larger than the sum total of the color pixels, and when pixels including a predetermined number of color pixels for each kind of color filter constitute one group, the color pixels or the pixels of the groups are dispersedly disposed with the monochrome pixels in between.

According this aspect of the invention, the effective sensitivity of the image sensor can be improved compared to the image sensors in which only color pixels where color filters are disposed are arranged and the conventional image sensors in which the sum total of the monochrome pixels is equal to or smaller than the sum total of the color pixels.

Consequently, since the effective sensitivity of the image sensor is improved, photographing with high sensitivity can be performed, so that a beautiful image with an excellent (high) S/N ratio can be obtained.

Moreover, in the above-described image sensor, color pixels where different color filters are disposed are arranged so as to adjoin in each pixel group.

According to this aspect of the invention, since color pixels where different color filters are disposed are arranged so as to adjoin in each pixel group, the generation of false colors (color moire) can be prevented or suppressed, so that a beautiful image can be obtained.

As the mode where color pixels are arranged so as to adjoin, for example, a mode where color pixels are arranged so as to adjoin each other and a mode where color pixels are arranged in a line (continuously) are considered.

Moreover, an image capturing apparatus of the present invention is provided with: a taking optical system that forms a light image of the subject; the above-described image sensor whose image capturing surface is disposed on an image forming surface of the taking optical system; an input operation portion for inputting instructions to start and end an exposure operation to the image sensor; an image generator that generates an image from a pixel signal obtained by the exposure operation by the image sensor; and an image display that displays the image generated by the image generator.

According to this aspect of the invention, since the effective sensitivity of the image sensor is improved, an image capturing apparatus with high photographing sensitivity can be obtained, so that a bright and beautiful image can be obtained.

Moreover, in the above-described image capturing apparatus, the image generator generates first brightness data in the positions of the monochrome pixels based on pixel signals obtained from the monochrome pixels, generates second brightness data in the positions of the color pixels by an interpolation processing using the first brightness data, generates first color data in the positions of the color pixels based on pixel signals obtained from the color pixels, and generates second color data in the positions of the monochrome pixels by an interpolation processing using the first color data.

According to this aspect of the invention, since the first brightness data in the positions of the monochrome pixels is generated based on the pixel signals obtained from the monochrome pixels with comparatively high sensitivity and the second brightness data in the positions of the color pixels are generated by the interpolation processing using the first brightness data, the apparent effective sensitivity of the image sensor can be improved, so that a bright and beautiful image can be obtained. Moreover, since the first color data in the positions of the color pixels is generated based on the pixel signals obtained from the color pixels and the second color data in the positions of the monochrome pixels is generated by the interpolation processing using the first color data, a color image can be generated even in the case of a pixel structure where the majority of the pixels are monochrome pixels having no color data. Since the sensitivity (resolution), to colors (hues and chromas), of the human eye is low, a taken image recognized as having high image quality can be generated even in the case of a color image generated in the above-described manner.

Moreover, in the above-described image capturing apparatus, the image generator further generates third brightness data in the positions of the color pixels based on the pixel signals obtained from the color pixels, generates fourth brightness data in the positions of the monochrome pixels by an interpolation processing using the third brightness data, and generates an image of the monochrome pixels whose brightness exceeds a predetermined threshold value by combining the first brightness data and the fourth brightness data.

According to this aspect of the invention, the third brightness data in the positions of the color pixels is generated based on the pixel signals obtained from the color pixels whose sensitivity range is shifted with respect to that of the monochrome pixels, the fourth brightness data in the positions of the monochrome pixels is generated by the interpolation processing using the third brightness data and an image of the monochrome pixels whose brightness exceeds a predetermined threshold value is generated by combining the first brightness data and the fourth brightness data, so that the gradation of the brightness can be easily increased. Consequently, an image with rich gradation can be obtained.

Moreover, in the above-described image capturing apparatus, a mode to cause the image sensor to perform the exposure operation a plurality of times at predetermined intervals is provided, and in the mode, the image generator selects a pixel row where both the color pixels and the monochrome pixels are present, from among a plurality of pixel rows where a plurality of pixels are arranged in one direction, and generates an image by use of the brightness data and the color data in the position of each pixel belonging to the selected pixel row.

According to this aspect of the invention, since in the mode to cause the image sensor to perform the exposure operation a plurality of times at predetermined intervals, a pixel row where both the color pixels and the monochrome pixels are present is selected from among a plurality of pixel rows where a plurality of pixels are arranged in one direction and an image is generated by use of the brightness data and the color data in the position of each pixel belonging to the selected pixel row, the color data can be obtained from only the selected pixel row. Consequently, a color image (moving image) can be generated. The moving image referred to here is a series of images obtained by causing the image sensor to perform the exposure operation a plurality of times at predetermined intervals to thereby generate an image from the pixel signals obtained by each exposure operation and displaying the images so as to be switched at predetermined intervals in an updated manner.

Moreover, in the above-described image capturing apparatus, an exposure condition determiner that determines the exposure condition of the image sensor is provided, and the exposure condition determiner determines the exposure condition by use of only the brightness data in the positions of the monochrome pixels.

According to this aspect of the invention, since the exposure condition is determined by use of only the brightness data of the monochrome pixels, compared to when the exposure condition is determined by use of the brightness data of the color pixels, the exposure control can be accurately performed even for a subject that is dark because of the sensitivity of the monochrome pixels being high.

Moreover, while in the conventional image sensors where color filters of, for example, R (red), G (green) and B (blue) are Bayer-arranged, the brightness data under a condition where no color filter is present in each pixel is generated from the pixel signals obtained from these color pixels and the exposure control is performed based on the brightness data, there is a possibility that an error with respect to the actual brightness of the subject is caused in the brightness data generation processing.

On the contrary, according to the present invention, since the brightness data under a condition where no color filter is present in each pixel is obtained from the monochrome pixels, the brightness data generation processing as described above is unnecessary, so that the above-mentioned error that can be caused because of the generation processing is never caused. The exposure control can be accurately performed also form this respect.

Although the resent invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image sensor, comprising:
a plurality of pixels arranged in a matrix and having pixels where at least three kinds of color filters are disposed,
wherein color pixels where the color filters are disposed and monochrome pixels where no color filter is disposed are provided, the sum total of the monochrome pixels is larger than the sum total of the color pixels, and when pixels including a predetermined number of color pixels for each kind of color filter constitute one group, the color pixels or the pixels of the groups are dispersedly disposed with the monochrome pixels in between.

2. An image sensor as claimed in claim 1, wherein the color pixels where different color filters are disposed are arranged so as to adjoin in each pixel group.

3. An image capturing apparatus, comprising:
a taking optical system for forming a light image of the subject;
an image sensor comprising a plurality of pixels arranged in a matrix and having pixels where at least three kinds of color filters are disposed, wherein color pixels where the color filters are disposed and monochrome pixels where no color filter is disposed are provided, the sum total of the monochrome pixels is larger than the sum total of the color pixels, when pixels including a predetermined number of color pixels for each kind of color filter constitute one group, the color pixels or the pixels of the groups are dispersedly disposed with the monochrome pixels in between, and whose image capturing surface is disposed on an image forming surface of the taking optical system;
an input operation portion for inputting instructions to start and end an exposure operation to the image sensor;
an image generator for generating an image from a pixel signal obtained by the exposure operation by the image sensor; and
an image display for displaying the image generated by the image generator.

4. An image capturing apparatus as claimed in claim 3, wherein the image generator generates first brightness data in the positions of the monochrome pixels based on pixel signals obtained from the monochrome pixels, generates second brightness data in the positions of the color pixels by an interpolation processing using the first brightness data, generates first color data in the positions of the color pixels based on pixel signals obtained from the color pixels, and generates second color data in the positions of the monochrome pixels by an interpolation processing using the first color data.

5. An image capturing apparatus as claimed in claim 4, wherein the image generator generates third brightness data in the positions of the color pixels based on the pixel signals obtained from the color pixels, generates fourth brightness data in the positions of the monochrome pixels by an interpolation processing using the third brightness data, and generates an image of the monochrome pixels whose brightness exceeds a predetermined threshold value by combining the first brightness data and the fourth brightness data.

6. An image capturing apparatus as claimed in claim 3, further comprising:
a mode setting portion for setting a mode to cause the image sensor to perform the exposure operation a plurality of times at predetermined intervals;
wherein the image generator selects a pixel row where both the color pixels and the monochrome pixels are present, from among a plurality of pixel rows where a plurality of pixels are arranged in one direction, and generates an image by use of the brightness data and the color data in the position of each pixel belonging to the selected pixel row in the mode.

7. An image capturing apparatus as claimed in claim 3, further comprising:
an exposure condition determiner for determining a exposure condition of the image sensor,
wherein the exposure condition determiner determines the exposure condition by use of only the brightness data in the positions of the monochrome pixels.

8. An image processing method for generating an image by use of pixel signals obtained from an image sensor comprising a plurality of pixels arranged in a matrix and having pixels where at least three kinds of color filters are disposed, wherein color pixels where the color filters are disposed and monochrome pixels where no color filter is disposed are provided, the sum total of the monochrome pixels is larger than the sum total of the color pixels, and when pixels including a predetermined number of color pixels for each kind of color filter constitute one group, the color pixels or the pixels of the groups are dispersedly disposed with the monochrome pixels in between, comprising:
a step of generating first brightness data in the positions of the monochrome pixels based on the pixel signals obtained from the monochrome pixels,
a step of generating second brightness data in the positions of the color pixels by an interpolation processing using the first brightness data,
a step of generating first color data in the positions of the color pixels based on the pixel signals obtained from the color pixels, and
a step of generating second color data in the positions of the monochrome pixels by an interpolation processing using the first color data.

9. An image processing method as claimed in claim 8, further comprising:
a step of generating third brightness data in the positions of the color pixels based on the pixel signals obtained from the color pixels,
a step of generating fourth brightness data in the positions of the monochrome pixels by an interpolation processing using the third brightness data, and
a step of generating an image of the monochrome pixels whose brightness exceeds a predetermined threshold value by combining the first brightness data and the fourth brightness data.
